(19) United States
(12) Patent Application Publication
(10) Pub. No.: US 2026/0281936 A1
(43) Pub. Date: Sep. 17, 2026

(54) USER EQUIPMENT (UE)

(71) Applicant: SHARP KABUSHIKI KAISHA, Sakai City, Osaka (JP)

(72) Inventor: YASUO SUGAWARA, Sakai City, Osaka (JP)

(21) Appl. No.: 19/472,817

(22) PCT Filed: Apr. 3, 2024
(86) PCT No.: PCT/JP2024/013686

§ 371 Date: Oct. 6, 2025

(30) Foreign Application Priority Data
Apr. 7, 2023 (JP) 2023-062521

(51) Int. Cl. H04W 60/00; H04W 48/16

(52) U.S. Cl. CPC H04W 60/002; H04W 48/16

(57) ABSTRACT

Although a UE is not storing allowed NSSAI for the current PLMN or SNPN, configured NSSAI for the current PLMN or SNPN, and/or default configured NSSAI, in a case that the UE is storing the partially allowed NSSAI and is in a TA in which S-NSSAI included in the partially allowed NSSAI is supported, the UE includes the S-NSSAI in requested NSSAI in a registration request message.

### TECHNICAL FIELD

The present invention relates to a User Equipment (UE). This application claims priority to JP 2023-062521 filed on Apr. 7, 2023, the contents of which are incorporated herein by reference.

### BACKGROUND ART

In 3rd Generation Partnership Project (3GPP), system architecture related to a fifth generation (5G) mobile communication system (also referred to as “5G System” or “5GS”) has been studied (see NPL1 to NPL3). In 3GPP, at present, as one of studies for specifications of Release 18, discussions related to enhancement of network slice (also referred to as NS) functions have been carried out (see NPL 4).

### CITATION LIST

### Non Patent Literature

NPL 1: 3GPP TS 23.501 V18.1.0 (2023 March); 3rd Generation Partnership Project; Technical Specification Group Services and System Aspects; System architecture for the 5G System (5GS); Stage 2 (Release 18)

NPL 2: 3GPP TS 23.502 V18.1.0 (2023 March); 3rd Generation Partnership Project; Technical Specification Group Services and System Aspects; Procedures for the 5G System (5GS); Stage 2 (Release 18)

NPL 3: 3GPP TS 24.501 V18.2.0 (2023 March); 3rd Generation Partnership Project; Technical Specification Group Core Network and Terminals; Non-Access-Stratum (NAS) protocol for 5G System (5GS); Stage 3; (Release 18)

NPL 4: 3GPP TR 23.700-41 V18.0.0 (2022 December); 3rd Generation Partnership Project; Technical Specification Group Services and System Aspects; Study on enhancement of network slicing; Phase 3 (Release 18)

### SUMMARY OF INVENTION

### Technical Problem

While NPL 4 discusses how to address the case that certain S-NSSAI is not available in all tracking areas (also referred to as “TAs”) included in a registration area (also referred to as an “RA”) but is available in some TAs in the RA, and not in the other TAs in the RA, it does not clarify details of UE behaviors and network (also referred to as an “NW”) behaviors.

One aspect of the present invention has been made in view of the above circumstances, and an object of the present invention is to clarify UE behaviors and NW behaviors for S-NSSAI that is available in some TAs in an RA but not in the other TAs in the RA.

### Solution to Problem

A user equipment (UE) according to an aspect of the present invention is a UE including a controller and a storage unit, in which, although the storage unit is not storing allowed NSSAI for the current PLMN or SNPN, configured NSSAI for the current PLMN or SNPN, and/or default configured NSSAI, in a case that the storage unit is storing partially allowed NSSAI and is in a TA in which S-NSSAI included in the partially allowed NSSAI is supported, the controller includes the S-NSSAI in requested NSSAI in a registration request message.

### Advantageous Effects of Invention

According to one aspect of the present invention, it is possible to clarify UE behaviors and NW behaviors for S-NSSAI that are available in some TAs in a registration area and that are not in the rest TAs in the registration area.

### BRIEF DESCRIPTION OF DRAWINGS

FIG. 1 is a diagram illustrating an overview of a mobile communication system (EPS/5GS).

FIG. 2 is a diagram illustrating a detailed configuration of the mobile communication system (EPS/5GS).

FIG. 3 is a diagram illustrating an apparatus configuration of a UE.

FIG. 4 is a diagram illustrating a configuration of an access network apparatus (gNB) in the 5GS.

FIG. 5 is a diagram illustrating a configuration of a core network apparatus (AMF/SMF) in the 5GS.

### DESCRIPTION OF EMBODIMENTS

A preferred embodiment for carrying out an aspect of the present invention will be described below with reference to the drawings. Note that an embodiment of a mobile communication system to which an aspect of the present invention is applied will be described as an example in the present embodiment.

### 1. Overview of System

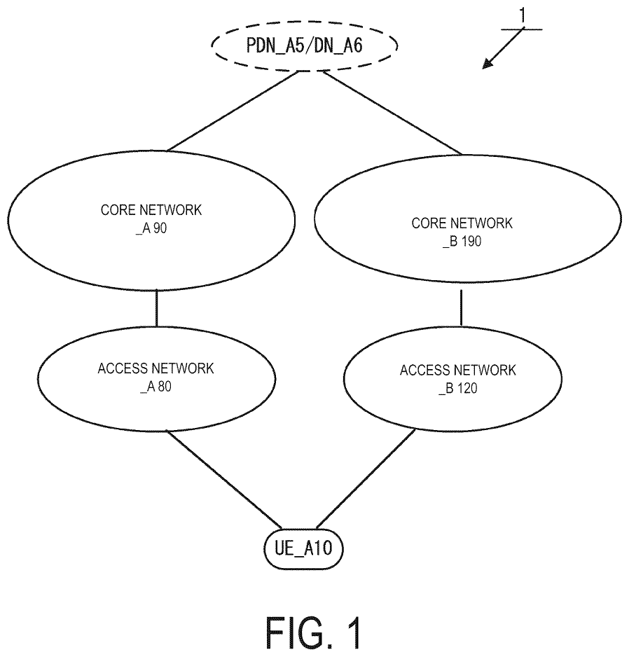

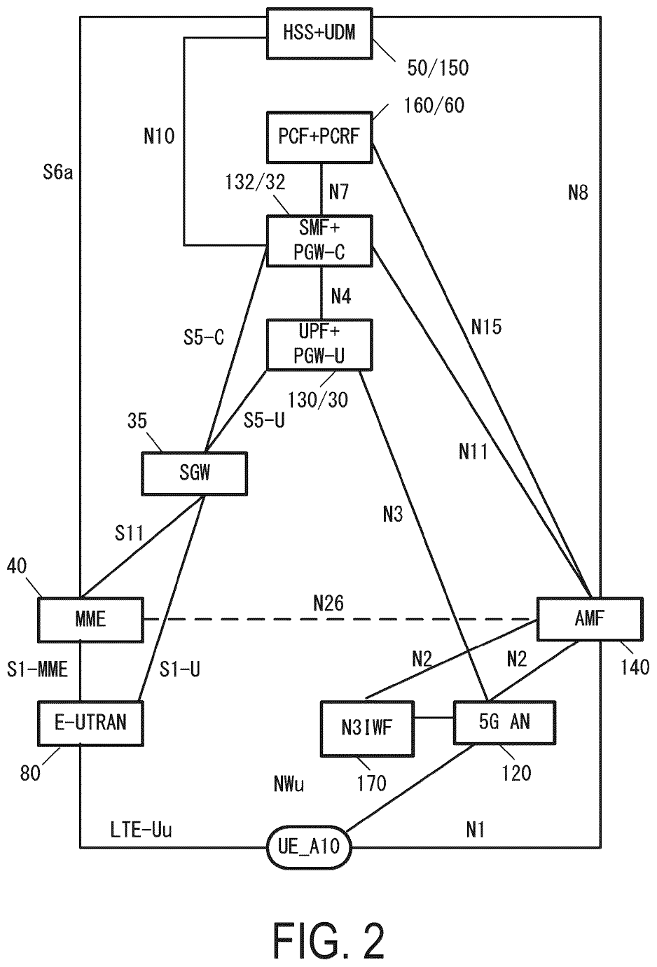

First, FIG. 1 is a diagram illustrating an overview of a mobile communication system 1 used in each embodiment, and FIG. 2 is a diagram illustrating a detailed configuration of the mobile communication system 1.

FIG. 1 illustrates the mobile communication system 1 including a UE_A 10, an access network_A 80, a core network_A 90, a Packet Data Network (PDN)_A 5, an access network B 120, a core network_B 190, and a Data Network (DN)_A 6.

In the following description, the reference numerals of these apparatuses and functions may be omitted, as in a UE, an access network_A, a core network_A, a PDN, an access network_B, a core network_B, a DN, and the like.

FIG. 2 illustrates apparatuses and functions such as the UE_A 10, an E-UTRAN 80, an MME 40, an SGW 35, a PGW-U 30, a PGW-C 32, a PCRF 60, an HSS 50, a 5G AN 120, an AMF 140, a UPF 130, an SMF 132, a PCF 160, a UDM 150, and an N3IWF 170, and interfaces for connecting these apparatuses and functions to each other.

In the following description, the reference numerals of these apparatuses and functions may be omitted as in a UE, an E-UTRAN, an MME, an SGW, a PGW-U, a PGW-C, a PCRF, an HSS, a 5G AN, an AMF, a UPF, an SMF, a PCF, a UDM, an N3IWF, and the like.

Note that an Evolved Packet System (EPS) that is a 4G system includes the access network A and the core network_A and may further include the UE and/or the PDN. A 5G System (5GS) that is a 5G system includes the UE, the access network_B, and the core network_B and may further include the DN.

The UE is an apparatus that can be connected to a network service over 3GPP access (also referred to as a 3GPP access network or a 3GPP AN) and/or non-3GPP access (also referred to as a non-3GPP access network or a non-3GPP AN). The UE may be a terminal apparatus capable of performing radio communication, such as a mobile phone or a smartphone, and may be a terminal apparatus that can be connected to both the EPS and the 5GS. The UE may include a Universal Integrated Circuit Card (UICC) and an Embedded UICC (eUICC). Note that the UE may be referred to as a user equipment or a terminal apparatus.

The access network_A corresponds to an Evolved Universal Terrestrial Radio Access Network (E-UTRAN) and/or a wireless LAN access network. In the E-UTRAN, one or more evolved Node Bs (eNBs) 45 are deployed. Note that, in the following description, the reference numeral of the eNB 45 may be omitted as in eNB. In a case that there are multiple eNBs, the eNBs are connected to each other via, for example, an X2 interface. One or more access points are deployed on the wireless LAN access network.

The access network_B corresponds to a 5G access network (5G AN). The 5G AN may be an NG Radio Access Network (NG-RAN) and/or a non-3GPP access network. One or more NR NodeBs (gNBs) 122 are deployed on the NG-RAN. Note that in the following description, the symbol for the gNB 122 may be omitted as a gNB. The gNB is a node that provides the UP and CP of New Radio (NR) to the UE and is connected to a 5GCN via an NG interface (including the N2 interface or the N3 interface). In other words, the gNB is a base station apparatus newly designed for the 5GS and has functions different from those of the base station apparatus (eNB) used in the EPS that is a 4G system. In a case that there are multiple gNBs, the gNBs are connected to each other via, for example, an Xn interface.

The non-3GPP access network may be an untrusted non-3GPP access network or may be a trusted non-3GPP access network. Here, the untrusted non-3GPP access network may be a non-3GPP access network that does not manage security on the access network, for example, a public wireless LAN. On the other hand, the trusted non-3GPP access network may be an access network defined by 3GPP and may include a trusted non-3GPP access point (TNAP) and a trusted non-3GPP Gateway function (TNGF).

In the following description, the E-UTRAN and the NG-RAN may be referred to as 3GPP access. The wireless LAN access network and the non-3GPP AN may be referred to as non-3GPP access. Nodes deployed on the access network_B may be collectively referred to as NG-RAN nodes.

In the following description, the access network_A, and/or the access network_B, and/or an apparatus included in the access network_A, and/or an apparatus included in the access network_B may be referred to as an access network or an access network apparatus.

The core network_A corresponds to an Evolved Packet Core (EPC). In the EPC, for example, a Mobility Management Entity (MME), a Serving Gateway (SGW), a Packet Data Network Gateway (PGW)-U, a PGW-C, a Policy and Charging Rules Function (PCRF), a Home Subscriber Server (HSS), and the like are deployed.

The core network_B corresponds to a 5G Core Network (5GCN). An Access and Mobility Management Function (AMF), a User Plane Function (UPF), a Session Management Function (SMF), a Policy Control Function (PCF), a Unified Data Management (UDM), and the like are deployed on the 5GCN. Here, the 5GCN may be referred to as a 5GC.

In the following description, the core network_A, and/or the core network_B, an apparatus included in the core network_A, and/or an apparatus included in the core network_B may be referred to as a core network, a core network apparatus, or an intra-core network apparatus.

The core network (the core network_A and/or the core network_B) may refer to an IP mobile communication network operated by a mobile communication (Mobile Network Operator (MNO)) connecting the access network (the access network_A and/or the access network_B) and the PDN and/or the DN, a core network for a mobile communication operator that operates and manages the mobile communication system 1, or a core network for a virtual mobile communication operator and a virtual mobile communication service provider such as a Mobile Virtual Network Operator (MVNO) and a Mobile Virtual Network Enabler (MVNE).

FIG. 1 illustrates a case that the PDN and the DN are the same; however, the PDN and the DN may be different. The PDN may be a Data Network (DN) that provides communication services to the UE. Note that the DN may be configured as a packet data service network or may be configured for each service. In addition, the PDN may include a connected communication terminal. Thus, “to be connected to the PDN” may mean “to be connected to a communication terminal and a server apparatus deployed in the PDN”. Furthermore, “to transmit and/or receive user data to and/or from the PDN” may mean “to transmit and/or receive user data to and/or from a communication terminal and a server apparatus deployed in the PDN”. Note that the PDN may be referred to as a DN, and the DN may be referred to as a PDN.

In the following, at least some of the access network_A, the core network_A, the PDN, the access network_B, the core network_B, and the DN, and/or one or more apparatuses included in these may be referred to as a network or a network apparatus. In other words, the expression that “the network and/or the network apparatus transmits and/or receives a message and/or performs a procedure” means that “at least some of the access network_A, the core network_A, the PDN, the access network_B, the core network_B, and the DN, and/or one or more apparatuses included in these transmit and/or receive a message and/or perform a procedure”.

The UE can be connected to the access network. The UE can be connected to the core network over the access network. Furthermore, the UE can be connected to the PDN or the DN over the access network and the core network. In other words, the UE can transmit and/or receive (communicate) user data to and/or from the PDN or the DN. In a case that user data is transmitted and/or received, not only Internet Protocol (IP) communication but also non-IP communication may be used.

Here, IP communication refers to data communication using an IP, and data is transmitted and/or received using IP packets. Each IP packet includes an IP header and a payload part. In the payload part, data transmitted and/or received by the apparatuses and functions included in the EPS and the apparatuses and functions included in the 5GS may be included. Non-IP communication refers to data communication performed without using IP, in which data is transmitted and/or received in a form different from the structure of an IP packet. For example, non-IP communication may be data communication implemented through transmission and/or reception of application data to which an IP header is not added, or user data transmitted and/or received by the UE may be transmitted and/or received with another header such as a MAC header and an Ethernet (trade name) frame header added.

Apparatuses which are not illustrated in FIG. 2 may be included in the access network_A, the core network_A, the access network_B, the core network_B, the PDN_A, and the DN_A. For example, the core network_A and/or the core network_B may include an Authentication Server Function (AUSF) and an Authentication, authorization, and accounting (AAA) server (AAA-S).

Here, the AUSF is a core network apparatus provided with an authentication function for 3GPP access and non-3GPP access. Specifically, the AUSF is a network function unit that receives an authentication request for 3GPP access and/or non-3GPP access from the UE and performs an authentication procedure.

The AAA server is an apparatus that is connected directly to the AUSF or indirectly to the AUSF via another network apparatus and has authentication, authorization, and billing functions. The AAA server may be a network apparatus within the core network. Note that the AAA server may not be included in the core network_A and/or the core network_B and may be included in the PLMN. In other words, the AAA server may be a core network apparatus or may be an apparatus outside the core network. For example, the AAA server may be a server apparatus within the PLMN managed by a 3rd party.

Note that, although each of the apparatuses and functions is illustrated one by one for simplicity in FIG. 2, multiple similar apparatuses and functions may be included in the mobile communication system 1. Specifically, multiple apparatuses and functions such as multiple pieces of UE_A 10, E-UTRANs 80, MMEs 40, SGWs 35, PGW-Us 30, PGW-Cs 32, PCRFs 60, HSSs 50, 5G ANs 120, AMFs 140, UPFs 130, SMFs 132, PCFs 160, and/or UDMs 150 may be included in the mobile communication system 1.

In addition, a network refers to at least some of the access network_B, the core network_B, and the DN. One or more apparatuses included in at least a part of the access network_B, the core network_B, and the DN may be referred to as a network or a network apparatus. In other words, “a network transmits and/or receives a message and/or performs processing” may mean “an apparatus (a network apparatus and/or a control apparatus) in the network transmits and/or receives the message and/or performs the processing”. Conversely, “an apparatus in a network transmits and/or receives a message and/or performs processing” may mean “the network transmits and/or receives the message and/or performs the processing”.

### 2. Configuration of Each Apparatus

Next, a configuration of each apparatus (the UE, and/or the access network apparatus, and/or the core network apparatus) used in each embodiment will be described with reference to the drawings. Note that each apparatus may be configured as physical hardware, may be configured as logical (virtual) hardware configured in general-purpose hardware, or may be configured as software. At least a part (including all) of the functions of each apparatus may be configured as physical hardware, logical hardware, or software.

Note that each of the storage units (storage unit_A 340, storage unit_B 540, and storage unit_B 740) in the apparatuses and functions appearing below includes, for example, a semiconductor memory, a Solid State Drive (SSD), a Hard Disk Drive (HDD), or the like. Each storage unit can store not only information originally configured at the time of being shipped, but also various pieces of information transmitted and/or received to and/or from apparatuses and functions (for example, the UE, and/or the access network apparatus, and/or the core network apparatus, and/or the PDN, and/or the DN) other than the apparatus and functions of each storage unit. Each storage unit can store identification information, control information, flags, parameters, and the like included in a control message transmitted and/or received in various communication procedures to be described later. Each storage unit may store these pieces of information for each UE. In a case that each storage unit performs interworking between the 5GS and the EPS, each storage unit can store a control message and user data transmitted and/or received to and/or from the apparatuses and functions included in the 5GS and/or the EPS. In this case, not only data transmitted and/or received over the N26 interface but also data transmitted and/or received without using the N26 interface can be stored.

### 2.1. Apparatus Configuration of UE

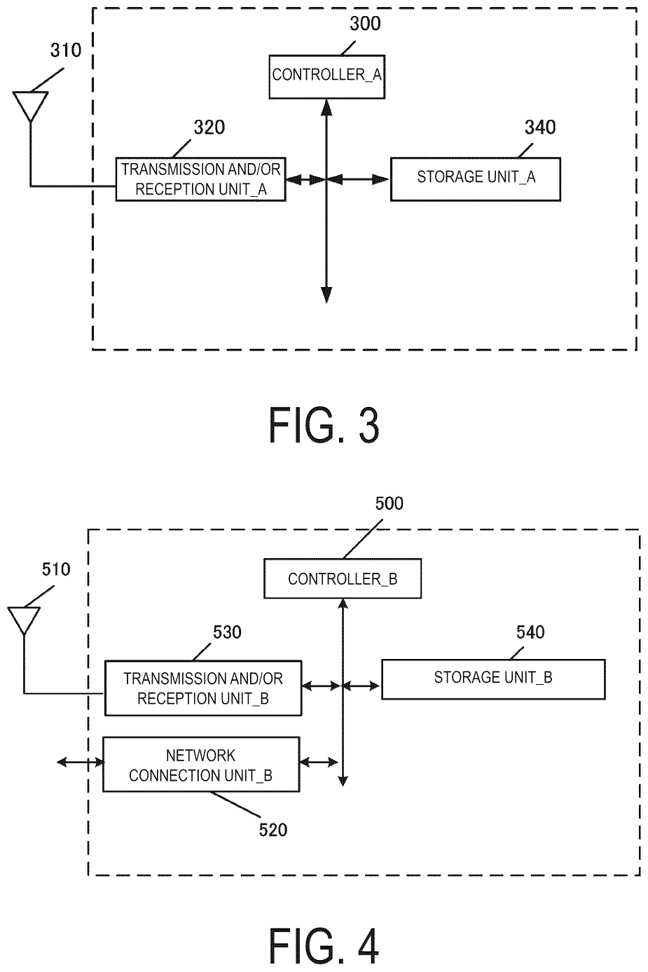

First, an apparatus configuration example of the User Equipment (UE) will be described with reference to FIG. 3. The UE includes a controller_A 300, an antenna 310, a transmission and/or reception unit_A 320, and a storage unit_A 340. The controller_A 300, the transmission and/or reception unit_A 320, and the storage unit_A 340 are connected via a bus. The transmission and/or reception unit_A 320 is connected to the antenna 310.

The controller A 300 is a function unit that controls overall operations and functions of the UE. The controller_A 300 reads and performs various programs stored in the storage unit_A 340 as necessary, and thereby implements various types of processing in the UE.

The transmission and/or reception unit_A 320 is a function unit that performs radio communication with a base station apparatus (the eNB or the gNB) within the access network via the antenna. In other words, with the use of the transmission and/or reception unit_A 320, the UE can transmit and/or receive user data and/or control information to and/or from the access network apparatus, and/or the core network apparatus, and/or the PDN, and/or the DN.

To provide detailed description with reference to FIG. 2, by using the transmission and/or reception unit_A 320, the UE can communicate with the base station apparatus (eNB) within the E-UTRAN over an LTE-Uu interface. The UE can communicate with the base station apparatus (gNB) within the 5G AN with the use of the transmission and/or reception unit_A 320. The UE can transmit and/or receive a Non-Access-Stratum (NAS) message to and/or from the AMF over an N1 interface with the use of the transmission and/or reception unit_A 320. However, the N1 interface is a logical interface, and thus communication between the UE and the AMF is actually performed over the 5G AN.

The storage unit_A 340 is a function unit that stores programs, user data, control information, and the like necessary for each operation of the UE. The storage unit_340 may have a function of storing control information transmitted and/or received to and/or from the access network apparatus, the core network apparatus, and the DN.

### 2.2. Apparatus Configuration of gNB

Next, an apparatus configuration example of the gNB will be described with reference to FIG. 4. The gNB includes a controller_B 500, an antenna 510, a network connection unit_B 520, a transmission and/or reception unit_B 530, and a storage unit_B 540. The controller_B 500, the network connection unit_B 520, the transmission and/or reception unit_B 530, and the storage unit B 540 are connected via a bus. The transmission and/or reception unit_B 530 is connected to the antenna 510.

The controller_B 500 is a function unit that controls overall operations and functions of the gNB. The controller_B 500 reads and performs various programs stored in the storage unit_B 540 as necessary, and thereby implements various types of processing in the gNB.

The network connection unit_B 520 is a function unit for the gNB to communicate with the AMF and/or the UPF. In other words, with the use of the network connection unit_B 520, the gNB can transmit and/or receive user data and/or control information to and/or from the AMF and/or the UPF.

The transmission and/or reception unit_B 530 is a function unit that performs radio communication with the UE via the antenna 510. In other words, with the use of the transmission and/or reception unit_B 530, the gNB can transmit and/or receive user data and/or control information to and/or from the UE.

To provide detailed description with reference to FIG. 2, by using the network connection unit_B 520, the gNB within the 5G AN can communicate with the AMF over the N2 interface and can communicate with the UPF over the N3 interface. The gNB can communicate with the UE with the use of the transmission and/or reception unit_B 530.

The storage unit_B 540 is a function unit that stores programs, user data, control information, and the like necessary for each operation of the gNB. The storage unit_540 may have a function of storing control information transmitted and/or received to and/or from the UE and another access network apparatus (base station apparatus), core network apparatus, and DN.

### 2.3. Apparatus Configuration of AMF

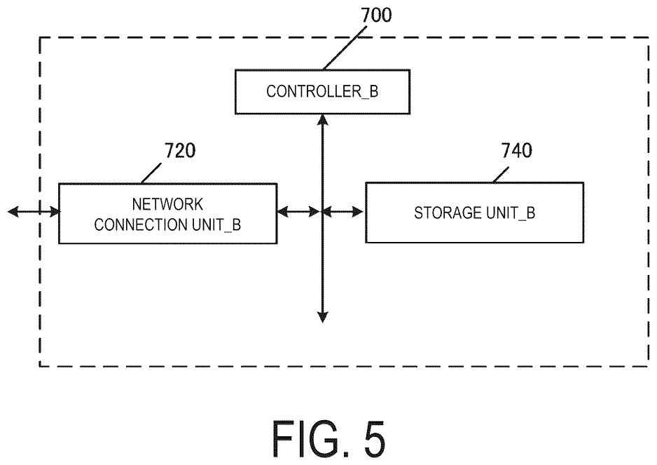

Next, an apparatus configuration example of the AMF will be described with reference to FIG. 5. The AMF includes a controller_B 700, a network connection unit_B 720, and a storage unit B 740. The controller_B 700, the network connection unit_B 720, and the storage unit_B 740 are connected via a bus. The AMF may be a node that handles the CP.

The controller B 700 is a function unit that controls overall operations and functions of the AMF. The controller_B 700 reads and performs various programs stored in the storage unit B 740 as necessary, and thereby implements various types of processing in the AMF.

The network connection unit_B 720 is a function unit for the AMF to connect to the base station apparatus (gNB), and/or the SMF, and/or the PCF, and/or the UDM, and/or the SCEF, and/or the NSACF in the 5G AN. In other words, with the use of the network connection unit B 720, the AMF can transmit and/or receive user data and/or control information to and/or from the base station apparatus (gNB) in the 5G AN, and/or the SMF, and/or the PCF, and/or the UDM, and/or the SCEF.

To provide detailed description with reference to FIG. 2, by using a network connection unit_A 620, the AMF within the 5GCN can communicate with the gNB over the N2 interface, can communicate with the UDM over an N8 interface, can communicate with the SMF over an N11 interface, and can communicate with the PCF over an N15 interface. The AMF can transmit and/or receive a NAS message to and/or from the UE over the N1 interface with the use of the network connection unit_A 620. However, the NI interface is a logical interface, and thus communication between the UE and the AMF is actually performed over the 5G AN. In a case that the AMF supports an N26 interface, the AMF can communicate with the MME over the N26 interface with the use of the network connection unit A 620.

The storage unit_B 740 is a function unit that stores programs, user data, control information, and the like necessary for each operation of the AMF. The storage unit_740 may have a function of storing control information transmitted and/or received to and/or from the UE, the access network apparatus, and another core network apparatus and DN.

Note that the AMF has a function of exchanging a control message with the RAN using the N2 interface, a function of exchanging a NAS message with the UE using the N1 interface, a function of performing encryption and integrity protection of a NAS message, a Registration management (RM) function, a Connection management (CM) function, a Reachability management function, a Mobility management function for the UE or the like, a function of transferring a Session Management (SM) message between the UE and the SMF, an Access Authentication (Access Authorization) function, a security anchor function (Security Anchor Functionality (SEA)), a Security Context Management (SCM) function, a function of supporting the N2 interface for a Non-3GPP Interworking Function (N3IWF), a function of supporting transmission and/or reception of a NAS signal to an/or from the UE via the N3IWF, a function of authenticating the UE connected via the N3IWF, and the like.

In registration management, an RM state for each UE is managed. The RM state may be synchronized between the UE and the AMF. The RM state includes a deregistered state (RM-DEREGISTERED state) and a registered state (RM-REGISTERED state). In the RM-DEREGISTERED state, because the UE is not registered with the network, the AMF is in a state of being unable to reach the UE, because a UE context in the AMF does not have location information and routing information that are valid for the UE. In the RM-REGISTERED state, because the UE is registered in the network, the UE can receive a service that requires registration with the network. Note that the RM state may be referred to as a 5GMM state. In this case, the RM-DEREGISTERED state may be referred to as a 5GMM-DEREGISTERED state, and the RM-REGISTERED state may be referred to as a 5GMM-REGISTERED state.

In other words, 5GMM-REGISTERED may be a state in which each apparatus establishes a 5GMM context, or may be a state in which each apparatus establishes a PDU session context. Note that, in a case that each apparatus is in 5GMM-REGISTERED, the UE A 10 may start transmission and/or reception of user data and a control message, or may respond to paging. Furthermore, note that, in a case that each apparatus is in 5GMM-REGISTERED, the UE_A 10 may perform a registration procedure other than a registration procedure for initial registration, and/or a service request procedure.

In addition, 5GMM-DEREGISTERED may be a state in which each apparatus does not establish the 5GMM context, may be a state in which the location information of the UE A 10 is not known to the network, or may be a state in which the network is unable to reach the UE A 10. Note that, in a case that each apparatus is in 5GMM-DEREGISTERED, the UE_A 10 may initiate the registration procedure, or may perform the registration procedure to thereby establish the 5GMM context.

In connection management, a CM state for each UE is managed. The CM state may be synchronized between the UE and the AMF. The CM state includes a non-connected state (CM-IDLE state) and a connected state (CM-CONNECTED state). In the CM-IDLE state, the UE is in the RM-REGISTERED state, but does not have NAS signaling connection established with the AMF via the N1 interface. In the CM-IDLE state, the UE has neither connection of the N2 interface (N2 connection) nor connection of the N3 interface (N3 connection). On the other hand, in the CM-CONNECTED state, the UE has NAS signaling connection established with the AMF via the N1 interface. In the CM-CONNECTED state, the UE may have connection of the N2 interface (N2 connection) and/or connection of the N3 interface (N3 connection).

Furthermore, in connection management, management may be performed separately for the CM state in 3GPP access and the CM state in non-3GPP access. In this case, the CM state in 3GPP access may include a non-connected state in 3GPP access (CM-IDLE state over 3GPP access) and a connected state in 3GPP access (CM-CONNECTED state over 3GPP access). Furthermore, the CM state in non-3GPP access may include a non-connected state in non-3GPP access (CM-IDLE state over non-3GPP access) and a connected state in non-3GPP access (CM-CONNECTED state over non-3GPP access). Note that the non-connected state may be referred to as an idle mode, and a connected state mode may be referred to as a connected mode.

Note that the CM state may be expressed as a 5GMM mode. In this case, the non-connected state may be referred to as a 5GMM non-connected mode (5GMM-IDLE mode), and the connected state may be referred to as a 5GMM connected mode (5GMM-CONNECTED mode). In addition, the non-connected state in 3GPP access may be referred to as a 5GMM non-connected mode in 3GPP access (5GMM-IDLE mode over 3GPP access), and the connected state in 3GPP access may be referred to as a 5GMM connected mode in 3GPP access (5GMM-CONNECTED mode over 3GPP access). In addition, the non-connected state in non-3GPP access may be referred to as a 5GMM non-connected mode in non-3GPP access (5GMM-IDLE mode over non-3GPP access), and the connected state in non-3GPP access may be referred to as a 5GMM connected mode in non-3GPP access (5GMM-CONNECTED mode over non-3GPP access). Note that the 5GMM non-connected mode may be referred to as an idle mode, and the 5GMM connected mode may be referred to as a connected mode.

One or more AMFs may be deployed within the core network_B. The AMF may be a Network Function (NF) that manages one or more Network Slice Instances (NSIs). The AMF may be a common CP function (Common Control Plane Network Function (CPNF)(CCNF)) shared among multiple NSIs.

Note that, in a case that the UE connects to the 5GS over non-3GPP access, the N3IWF is an apparatus and/or a function deployed between non-3GPP access and the 5GCN.

### 2.4. Apparatus Configuration of SMF

Next, an apparatus configuration example of the SMF will be described with reference to FIG. 5. The SMF includes a controller_B 700, a network connection unit_B 720, and a storage unit B 740. The controller_B 700, the network connection unit_B 720, and the storage unit_B 740 are connected via a bus. The SMF may be a node that handles the CP.

The controller B 700 is a function unit that controls overall operations and functions of the SMF. The controller_B 700 reads and performs various programs stored in the storage unit B 740 as necessary, and thereby implements various types of processing in the SMF.

The network connection unit B 720 is a function unit for the SMF to connect to the AMF, and/or the UPF, and/or the PCF, and/or the UDM. In other words, with the use of the network connection unit_B 720, the SMF can transmit and/or receive user data and/or control information to and/or from the AMF, and/or the UPF, and/or the PCF, and/or the UDM, and/or the NSACF.

To provide detailed description with reference to FIG. 2, by using of the network connection unit_A 620, the SMF in the 5GCN can communicate with the AMF over the N11 interface, can communicate with the UPF over the N4 interface, can communicate with the PCF over an N7 interface, and can communicate with the UDM over an N10 interface.

The storage unit_B 740 is a function unit that stores programs, user data, control information, and the like necessary for each operation of the SMF.

The SMF has a Session Management function for managing establishment, modification, and release of a PDU session, a function of IP address allocation to the UE and management thereof, a function of selection and control of the UPF, a function of configuring the UPF for routing traffic to an appropriate destination (transmission destination), a function of transmitting and/or receiving an SM part of a NAS message, a function of providing notification of arrival of downlink data (Downlink Data Notification), a function of providing SM information specific to an AN (for each AN) that is transmitted to the AN through the AMF over the N2 interface, a function of determining a Session and Service Continuity mode (SSC mode) for a session, a roaming function, and the like.

The storage unit_740 may have a function of storing control information transmitted and/or received to and/or from the UE, the access network apparatus, and another core network apparatus and DN.

### 2.5. Apparatus Configuration of UPF

Next, an apparatus configuration example of the UPF will be described with reference to FIG. 5. The UPF includes a controller_B 700, a network connection unit_B 720, and a storage unit B 740. The controller_B 700, the network connection unit_B 720, and the storage unit_B 740 are connected via a bus. The UPF may be a node that handles the UP or CP.

The controller B 700 is a function unit that controls overall operations and functions of the UPF. The controller_B 700 reads and performs various programs stored in the storage unit_B 740 as necessary, and thereby implements various types of processing in the UPF.

The network connection unit_B 720 is a function unit for the UPF to connect to the base station apparatus (gNB) within the 5G AN, and/or the SMF, and/or the DN. In other words, with the use of the network connection unit_B 720, the UPF can transmit and/or receive user data and/or control information to and/or from the base station apparatus (gNB) within the 5G AN, and/or the SMF, and/or the DN.

To provide detailed description with reference to FIG. 2, by using the network connection unit_A 620, the UPF within the 5GCN can communicate with the gNB over the N3 interface, can communicate with the SMF over the N4 interface, can communicate with the DN over an N6 interface, and can communicate with another UPF over an N9 interface.

The storage unit_B 740 is a function unit that stores programs, user data, control information, and the like necessary for each operation of the UPF.

The UPF has a function as an anchor point for intra-RAT mobility or inter-RAT mobility, a function as an external PDU session point to be interconnected with the DN (that is, a function of transferring user data as a gateway between the DN and the core network_B), a function of routing and transferring packets, an Uplink Classifier (UL CL) function of supporting routing of multiple traffic flows for one DN, a Branching point function of supporting a multi-homed PDU session, a Quality of Service (QoS) processing function for the user plane, a function of verifying uplink traffic, a function of triggering buffering of downlink packets and Downlink Data Notification, and the like.

The UPF may be a gateway for IP communication and/or non-IP communication. The UPF may have a function of transferring IP communication, or a function of conversion between non-IP communication and IP communication. Furthermore, multiple deployed gateways may be gateways for connecting the core network_B and a single DN. Note that the UPF may have connectivity with another NF, and may be connected to each apparatus via another NF.

The storage unit_740 may have a function of storing control information transmitted and/or received to and/or from the UE, the access network apparatus, and another core network apparatus and DN.

Note that the user plane (U-Plan; also referred to as a UP) refers to user data that is transmitted and/or received between the UE and the network. The UP may be transmitted and/or received using a PDN connection in 4G, or a PDU session in 5G. Furthermore, in the EPS, the UP may be transmitted and/or received using an LTE-Uu interface, and/or an S1-U interface, and/or an S5 interface, and/or an S8 interface, and/or an SGi interface. Furthermore, in the 5GS, the UP may be transmitted and/or received over the interface between the UE and the NG RAN, and/or the N3 interface, and/or the N9 interface, and/or the N6 interface. In addition, the UP may be a communication path for transmitting and/or receiving user data, and may include multiple bearers. In addition, UP resources are those associated with the UP, and may be a PDN connection or a PDU session itself, may be user data using the PDN connection or the PDU session, may be a configuration for the PDN connection or the PDU session, or may be a configuration for transmitting and/or receiving user data using the PDN connection or the PDU session. Further, activating UP resources may be enabling the UP resources, and deactivating the UP resources may be disabling the UP resources.

Further, the control plane (C-Plan; also referred to as a “CP”) refers to a control message that is transmitted and/or received in order to perform communication control of the UE, or the like. The CP may be transmitted and/or received using Non-Access-Stratum (NAS) signaling connection between the UE and the MME. The CP may be transmitted and/or received using Non-Access-Stratum (NAS) signaling connection between the UE and the AMF. Further, in the EPS, the CP may be transmitted and/or received using the LTE-Uu interface and an S1-MME interface. Furthermore, in the 5GS, the CP may be transmitted and/or received using the interface between the UE and the NG RAN and the N2 interface. Furthermore, the CP may be a communication path for transmitting and/or receiving control messages, and may include multiple bearers.

2.6. Description About Other Apparatuses and/or Functions and Control Information According to Present Embodiment

Next, other apparatuses or functions, terminology, control information and control messages transmitted and/or received, stored, and managed by each apparatus or function, and the like will be described.

Note that the control information and control messages may be information stored in advance in the UE, and/or the base station, and/or the AMF, and/or the SMF, and/or a core network apparatus/function (e.g., NSSF, PCF, or the like) other than the AMF, and/or the SMF, and a part thereof may be stored in advance, or may be stored in association with transmission and/or reception of the control information.

A Network Slice Selection Function (NSSF) may be a network function (also referred to as an NF) having a function of selecting a network slice serving the UE.

A Network Data Analytics Function (NWDAF) may be an NF having a function of performing data collection from an NF and an application function (also referred to as an AF).

A Policy Control Function (PCF) may be an NF having a function of determining a policy for controlling a behavior of a network.

A Network Repository Function (NRF) may be an NF having a service discovery function. The NRF may be an NF that has a function of providing information of a discovered NF in a case of receiving a discovery request of another NF from a certain NF.

The Network Slice Admission Control Function (NSACF) may have a function of monitoring and controlling the number of UEs registered per NS and/or the number of PDU sessions per NS regarding the network slice (NS) related to Network Slice Admission Control (NSAC). The NSACF may be configured using the maximum number of UEs per NS and/or the maximum number of PDU sessions per NS allowed for each NS related to NSAC. The NSACF may have a function of increasing and decreasing the number of UEs registered with a certain NS so that the number does not exceed the maximum number of UEs allowed to be registered with the NS. The NSACF may maintain a list of UE IDs registered with the NS related to NSAC. The NSACF may have the following function: in a case that the number of UEs registered with the NS is increased (for example, in a case that a certain UE newly transmits a registration request message to the NS), the NSACF confirms whether the ID of the UE is already included in the list of UE IDs registered with the NS, and in a case that the ID of the UE is not included in the list, the NSACF further confirms whether the maximum number of UEs per NS is reached for the NS. In a case that a registered state (registration status) of the UE for the NS related to NSAC changes during the registration procedure, and/or the de-registration procedure, and/or the NSSAA procedure, and/or the like, the AMF may make a request related to the maximum number of UEs per NS to the NSACF. The NSACF may have a function of increasing and decreasing the number of PDU sessions for a certain NS so that the number does not exceed the maximum number of PDU sessions allowed for the NS. The NSACF may have the following function: in a case that the number of PDU sessions using the NS is increased (for example, in a case that a certain UE transmits a PDU session establishment request message for the NS), the NSACF confirms whether the maximum number of UEs per NS is reached for the NS. The SMF may make a request related to the maximum number of PDU sessions per NS to the NSACF during the PDU session establishment procedure, and/or the PDU session release procedure.

In addition, an SM procedure (also referred to as a “procedure for SM”) may include a PDU session establishment procedure initiated by the UE, a PDU session modification procedure initiated by the UE or SMF, and a PDU session release procedure initiated by the UE or SMF (UE-requested PDU session release procedure).

Here, in the PDU session establishment procedure, the UE may transmit a PDU session establishment request message to the SMF, and the SMF that has received the message may transmit a PDU session establishment accept message or a PDU session establishment reject message to the UE. Here, the SMF transmits a PDU session establishment accept message in a case of accepting a PDU session establishment request from the UE, or may transmit a PDU session establishment reject message in a case of not accepting the request.

In addition, in the PDU session modification procedure initiated by the UE, the UE may transmit a PDU session modification request message to the SMF, and the SMF that has received the message may perform the PDU session modification procedure initiated by the SMF or may transmit a PDU session modification reject message to the UE. Here, the SMF may perform the PDU session modification procedure initiated by the SMF in a case of accepting a PDU session modification request from the UE, or may transmit a PDU session modification reject message in a case of not accepting the message.

In addition, in the PDU session modification procedure initiated by the SMF, the SMF may transmit a PDU session modification command message to the UE, and the UE that has received the message may transmit a PDU session modification complete message or a PDU session modification command reject message to the SMF. Here, the UE may transmit the PDU session modification complete message in a case of accepting the PDU session modification command from the SMF, or may transmit a PDU session modification command reject message in a case of not accepting the command.

In addition, in the PDU session release procedure initiated by the UE, the UE may transmit a PDU session modification request message to the SMF, and the SMF that has received the message may perform the PDU session release procedure initiated by the SMF or may transmit a PDU session release reject message to the UE. Here, the SMF may perform the PDU session release procedure initiated by the SMF in a case of accepting a PDU session release request from the UE, or may transmit a PDU session release reject message in a case of not accepting the message.

In addition, in the PDU session release procedure initiated by the SMF, the SMF may transmit a PDU session release command message to the UE, and the UE that has received the message may transmit a PDU session release complete message to the SMF.

In addition, a Mobility Management (MM) message may be a control message transmitted and/or received between the UE and the AMF in an MM procedure, and may be a NAS message (also referred to as a NAS MM message).

In addition, a Session Management (SM) message (also referred to as a Non-Access-Stratum (NAS) SM message) may be a control message transmitted and/or received between the UE and the SMF via the AMF in an SM procedure, or may be a NAS message (also referred to as a “NAS SM message”).

In addition, the MM procedure (also referred to as a “procedure for MM”) may include a Registration procedure initiated by the UE, a De-registration procedure initiated by the UE or the AMF, a Generic UE configuration update procedure initiated by the AMF, a Service request procedure initiated by the UE, a Paging procedure initiated by the AMF, and a Notification procedure initiated by the AMF.

Here, in the registration procedure, the UE may transmit a Registration request message to the AMF, and the AMF that has received the message may transmit a Registration accept message or a Registration reject message to the UE. Here, the AMF may transmit a registration accept message in a case of accepting the registration request from the UE, or may transmit a registration reject message in a case of not accepting the registration request.

In addition, in the de-registration procedure initiated by the UE, the UE may transmit a De-registration request message to the AMF, and the AMF that has received the message may transmit a De-registration accept message to the UE.

In addition, in the de-registration procedure initiated by the AMF, the AMF may transmit a de-registration request message to the UE, and the UE that has received the message may transmit a de-registration accept message to the AMF.

In addition, in the generic UE configuration update, the AMF may transmit a configuration update command message to the UE, and the UE that has received the configuration update command message may transmit a configuration update complete message to the AMF.

In addition, in the service request procedure, the UE may transmit a Service request message to the AMF, and the AMF that has received the service request message may transmit a Service accept message or a Service reject message to the UE. Here, the AMF may transmit a registration accept message in a case of accepting the service request from the UE, or may transmit a service reject message in a case of not accepting the service request.

In the paging procedure, the AMF may transmit a paging request (Request Paging) to the base station, the base station that has received the paging request may transmit a Paging message to the UE, and the UE that has received the paging message may transmit a service request message or a registration request message to the AMF.

In addition, in the notification procedure, the AMF may transmit a Notification message to the UE, and the UE that has received the notification message may transmit a Notification response message to the AMF, or may transmit a service request message or a registration request message to the AMF.

In addition, a Mobility Management (MM) message may be a control message transmitted and/or received between the UE and the AMF in the MM procedure, and may be a NAS message (also referred to as a NAS MM message).

A 5G System (5GS) service may be a connection service provided using the core network B 190. In addition, the 5GS service may be a service different from an EPS service, or may be a service similar to the EPS service.

A non 5GS service may be a service other than the 5GS service and may include an EPS service and/or a non EPS service.

Although a Protocol Data Unit (PDU) session can be defined as a relationship between the DN that provides a PDU connectivity service and the UE, the PDU session may be connectivity established between the UE and an external gateway. In the 5GS, the UE establishes a PDU session via the access network_B and the core network_B, and can thereby perform transmission and/or reception of user data to and/or from the DN by using the PDU session. Here, the external gateway may be a UPF, an SCEF, or the like. The UE can perform transmission and/or reception of user data to and/or from an apparatus deployed in the DN, such as an application server, by using the PDU session.

Note that each apparatus (the UE, and/or the access network apparatus, and/or the core network apparatus) may associate one or more pieces of identification information with a PDU session for management. Note that these pieces of identification information may include one or more of a DNN, a QoS rule, a PDU session type, application identification information, NSI identification information, and access network identification information, and may further include other pieces of information. In addition, in a case that multiple PDU sessions are established, pieces of identification information associated with the PDU sessions may have the same or different details.

The Data Network Name (DNN) may be identification information for identifying the core network and/or an external network such as the DN. The DNN can also be used as information for selecting a gateway such as the PGW_A 30/UPF_A 235 for connecting to the core network B 190. In addition, the DNN may correspond to an Access Point Name (APN).

A Protocol Data Unit/Packet Data Unit (PDU) session type indicates a type of PDU session and includes IPv4, IPv6, Ethernet, and Unstructured. In a case that IPv4 is specified, it indicates that transmission and/or reception of data is performed using IPv4. In a case that IPv6 is specified, it indicates that transmission and/or reception of data is performed using IPv6. In a case that Ethernet is specified, it indicates that transmission and/or reception of an Ethernet frame is performed. Ethernet may indicate that communication using the IP is not performed. In a case that Unstructured is specified, it indicates that data is transmitted and/or received to and/or from an application server in the DN or the like by using a Point-to-Point (P2P) tunneling technique. For the P2P tunneling technique, for example, a UDP/IP encapsulation technique may be used. Note that the PDU session type may include the IP, in addition to the above. The IP can be specified in a case that the UE can use both of IPv4 and IPv6.

The Public land mobile network (PLMN) is a communication network that provides mobile radio communication services. The PLMN is a network managed by an operator who is a network operator, and the operator can be identified by a PLMN ID. A PLMN that matches a Mobile Network Code (MNC) and a Mobile Country Code (MCC) of an International Mobile Subscriber Identity (IMSI) of the UE may be a Home PLMN (HPLMN). Furthermore, the UE may hold, in the USIM, an Equivalent HPLMN list for identifying one or multiple Equivalent HPLMNs (EPLMNs). A PLMN different from the HPLMN and/or the EPLMN may be a Visited PLMN (VPLMN). A PLMN with which the UE has been successfully registered may be a Registered PLMN (also referred to as a registered PLMN) (RPLMN). Note that a service provided by the PLMN may be referred to as a PLMN service, and a service provided by an SNPN may be referred to as an SNPN service.

In addition, a network slice (NS) is a logical network that provides specific network capability and network characteristics. The UE and/or the network can support the network slice (NW slice (NS)) in the 5GS. The network slice may be referred to simply as a slice. In addition, the NS may mean a dedicated network, a core network, or a system configured to provide a specific service.

In addition, a network slice instance (NSI) includes a set of an instance (entity) of a network function (NF) and necessary resources and forms a network slice to be mapped. Here, the NF is a processing function for a network, and is adopted or defined by the 3GPP. The NSI is an entity of one or more NSs configured in the core network_B. In addition, the NSI may include a virtual Network Function (NF) generated using a Network Slice Template (NST). Here, the NST is associated with a resource request for provision of a requested communication service and capability, and is a logical expression of one or more NFs. In other words, the NSI may be a set of multiple NFs on the core network_B 190. The NSI may be a logical network configured for classifying user data to be delivered depending on a service or the like. In the NS, one or more NFs may be configured. Each NF configured in the NS may or may not be an apparatus shared with another NS. The UE and/or the apparatus in the network can be allocated to one or more NSs, based on NSSAI, and/or S-NSSAI, and/or a UE usage type, and/or registration information such as one or more NSI IDs, and/or an APN. Note that the UE usage type is a parameter value included in registration information of the UE, which is used for identifying the NSI. The UE usage type may be stored in the HSS. The AMF may select the SMF and the UPF based on the UE usage type.

In addition, Single Network Slice Selection Assistance Information (S-NSSAI) is information for identifying the NS. The S-NSSAI may include only a Slice/Service type (SST), or may include an SST and a Slice Differentiator (SD). Here, the SST is information indicating an operation of the NS expected in terms of functions and services. In addition, the SD may be information for interpolating an SST in a case that one NSI is selected out of multiple NSIs indicated by the SST. The S-NSSAI may be information unique to each PLMN or may be standard information common to the PLMNs. In addition, a network may store one or more pieces of S-NSSAI in the registration information of the UE as default S-NSSAI. Note that, in a case that the S-NSSAI is default S-NSSAI and the UE does not transmit, to a network, valid S-NSSAI in a registration request message, the network may provide an NS related to the UE.

In addition, the Network Slice Selection Assistance Information (NSSAI) is a set of pieces of the S-NSSAI. Each piece of the S-NSSAI included in the NSSAI is information for assisting the access network or the core network to select an NSI. The UE may store the NSSAI allowed by the network for each PLMN. In addition, the NSSAI may be information used for selecting the AMF.

In addition, configured NSSAI (also referred to as Configured NSSAI) is NSSAI supplied and stored in the UE. The UE may store the configured NSSAI for each PLMN. The configured NSSAI may be information configured by the network (or PLMN). The S-NSSAI included in the configured NSSAI may be referred to as configured S-NSSAI. The configured S-NSSAI may include S-NSSAI and mapped S-NSSAI.

In addition, requested NSSAI (also referred to as Request NSSAI) is NSSAI provided to the network from the UE during the registration procedure. The requested NSSAI may be allowed NSSAI or configured NSSAI stored by the UE. Specifically, the requested NSSAI may be information indicating a network slice that the UE is to access. The S-NSSAI included in the requested NSSAI may be referred to as requested S-NSSAI. For example, the requested NSSAI is included in a Non-Access-Stratum (NAS) message transmitted from the UE to the network, such as a registration request message or a PDU session establishment request message, or in a Radio Resource Control (RRC) message including the NAS message and then transmitted.

In addition, allowed NSSAI (also referred to as Allowed NSSAI) is information indicating one or multiple network slices allowed for the UE. In other words, the allowed NSSAI is information identifying a network slice to which the UE is allowed to connect by the network. As information of the UE, each of the UE and the network stores and manages the allowed NSSAI for each access (3GPP access or non-3GPP access). The S-NSSAI included in the allowed NSSAI may be referred to as an allowed S-NSSAI. The allowed S-NSSAI may include S-NSSAI and mapped S-NSSAI.

In addition, mapped S-NSSAI (also referred to as Mapped S-NSSAI) may be S-NSSAI for the HPLMN mapped to the S-NSSAI for a registered PLMN in a roaming scenario (i.e., during roaming). Basically, the mapped S-NSSAI may be S-NSSAI used in a case that the UE is roaming, or may be S-NSSAI not used in a case that the UE is not roaming (also referred to as a case of non-roaming). The UE may store one or multiple pieces of mapped S-NSSAI mapped to the configured NSSAI and the S-NSSAI included in the Allowed NSSAI of each access type. The UE may store one or multiple pieces of mapped S-NSSAI included in the rejected NSSAI, or mapped S-NSSAI corresponding to the S-NSSAI included in the rejected NSSAI.

In addition, rejected NSSAI (also referred to as Rejected NSSAI) is information indicating one or multiple network slices not allowed for the UE. In other words, the rejected NSSAI is information identifying a network slice to which the UE is not allowed to connect by the network. The rejected NSSAI may be information including one or multiple combinations of S-NSSAI and a reject cause value (hereinafter also referred to as a cause value or a rejection cause). Here, the reject cause value is information indicating why the network rejects the corresponding S-NSSAI. The UE and the network may each appropriately store and manage the rejected NSSAI based on the reject cause value associated with each piece of S-NSSAI. Furthermore, the rejected NSSAI may be included in the NAS message transmitted from the network to the UE, such as a registration accept message, a configuration update command, or a registration reject message, or in an RRC message including a NAS message. The S-NSSAI included in the rejected NSSAI may be referred to as rejected S-NSSAI. Here, the rejected NSSAI may mean one of the second or fourth rejected NSSAI. In addition, the rejected S-NSSAI may mean the rejected S-NSSAI included in one of the second or fourth rejected NSSAI. In addition, the second rejected S-NSSAI may be S-NSSAI included in the second rejected NSSAI and the fourth rejected S-NSSAI may be S-NSSAI included in the fourth rejected NSSAI. In addition, the rejected NSSAI may be one of the second to fourth rejected NSSAI and the pending NSSAI, or may be a combination of these. The S-NSSAI included in the rejected NSSAI may be referred to as rejected S-NSSAI. The rejected S-NSSAI may include the S-NSSAI and the mapped S-NSSAI.

Here, the second rejected NSSAI may be the rejected NSSAI for the current RA. In other words, the second rejected NSSAI may be the NSSAI not available in the current RA. In addition, the second rejected NSSAI may be one piece or a set of multiple pieces of S-NSSAI not available in the current RA among the pieces of S-NSSAI included in the requested NSSAI by the UE. In addition, the second rejected S-NSSAI may be rejected S-NSSAI for the current registration area. The second rejected NSSAI may be a rejected NSSAI stored by the UE and/or the NW, or may be a rejected NSSAI transmitted from the NW to the UE. In a case that the second rejected NSSAI is the rejected NSSAI transmitted from the NW to the UE, the second rejected NSSAI may be information including one or multiple combinations of S-NSSAI and a cause value. The cause value may indicate “S-NSSAI not available in the current registration area (RA)”, which means that the S-NSSAI associated with the cause value is not available in the current RA.

In addition, the second rejected NSSAI may be valid in the current RA. In other words, the UE and/or the NW may treat the second rejected NSSAI and the S-NSSAI included in the second rejected NSSAI as information for each access type. In other words, the second rejected NSSAI may be information valid for each of 3GPP access and non-3GPP access. In other words, once the UE transitions to the deregistered state for one access, the UE may delete the second rejected NSSAI from the storage.

In addition, the S-NSSAI included in the second rejected NSSAI in the storage unit of the UE may be handled as unavailable in the current RA. In other words, the UE may be in a state of being forbidden from initiating the MM procedure and/or the SM procedure using the S-NSSAI in the current RA.

In addition, the fourth rejected NSSAI may be the rejected NSSAI for the current tracking area (TA). In other words, the fourth rejected NSSAI may be the NSSAI not available in the current TA. Note that, in the present specification, the fourth rejected NSSAI may be referred to as partially rejected NSSAI. In addition, the fourth rejected S-NSSAI may be referred to as partially rejected S-NSSAI.

In addition, the fourth rejected NSSAI may be the rejected NSSAI for the current tracking area (TA) in the current registration area (RA). In other words, the fourth rejected NSSAI may be the NSSAI not available in the current TA in the current RA.

In addition, the fourth rejected NSSAI may be the NSSAI not available in the current TA in the current RA, and the NSSAI available in another TA in the current RA.

In addition, the fourth rejected NSSAI may be the NSSAI not available in the current TA in the current RA, and the NSSAI available in another TA in the current RA or another RA (different from the current RA).

In addition, the fourth rejected NSSAI may be a set of S-NSSAI included in a requested NSSAI by the UE, and a set of S-NSSAI not available in the current TA or S-NSSAI transmitted using the rejection cause indicating that the S-NSSAI is not available in the current TA by the AMF.

In the roaming scenario (during roaming), the fourth rejected NSSAI may include one or more pieces of S-NSSAI for the current PLMN, and may include a set of mapped S-NSSAI in a case of being available.

The fourth rejected NSSAI may be a rejected NSSAI stored by the UE and/or the NW, or may be a rejected NSSAI transmitted from the NW to the UE. In a case that the fourth rejected NSSAI is a rejected NSSAI transmitted from the NW to the UE, the fourth rejected NSSAI may be information including one or multiple combinations of S-NSSAI and a cause value. The cause value may be 12th identification information.

In addition, the fourth rejected NSSAI may be valid for 3GPP access and/or non-3GPP access. In other words, the UE and/or the NW may handle the fourth rejected NSSAI as that not dependent on the access type, or may handle the fourth rejected NSSAI as that dependent on the access type. In still other words, the UE and/or the NW may manage and/or store the fourth rejected NSSAI for each access type, or need not manage and/or store the fourth rejected NSSAI for each access type.

Here, the fact that the fourth rejected NSSAI is not dependent on the access type may mean that, for example, in a case that the UE receives the fourth rejected NSSAI via the 3GPP access, the fourth rejected NSSAI or the S-NSSAI included in the fourth rejected NSSAI is not only unavailable via the 3GPP access but also unavailable via the non-3GPP access. Similarly, in a case that the UE receives the fourth rejected NSSAI via the non-3GPP access, this may mean that the fourth rejected NSSAI or the S-NSSAI included in the fourth rejected NSSAI is not only unavailable via the 3GPP access but also unavailable via the non-3GPP access. Note that, in a case that the fourth rejected NSSAI is not dependent on the access type, the UE and/or the NW desirably does not store the fourth rejected NSSAI for each access type (that is, does not store the fourth rejected NSSAI separately for each access type but simply stores the fourth rejected NSSAI), but the present invention is not limited thereto.

In addition, the case where the fourth rejected NSSAI is dependent on the access type may mean that, for example, in a case that the UE receives the fourth rejected NSSAI via the 3GPP access, the fourth rejected NSSAI or the S-NSSAI included in the fourth rejected NSSAI is unavailable via the 3GPP access, but need not mean that the fourth rejected NSSAI or the S-NSSAI included in the fourth rejected NSSAI is unavailable via the non-3GPP access. In other words, this may mean that the use of the fourth rejected NSSAI or the S-NSSAI included in the fourth rejected NSSAI via the non-3GPP access is not limited. Similarly, in a case that the UE receives the fourth rejected NSSAI via the non-3GPP access, this may mean that the fourth rejected NSSAI or the S-NSSAI included in the fourth rejected NSSAI is unavailable via the non-3GPP access, but need not mean that the fourth rejected NSSAI or the S-NSSAI included in the fourth rejected NSSAI is unavailable via the 3GPP access. In other words, this may mean that the use of the fourth rejected NSSAI or the S-NSSAI included in the fourth rejected NSSAI via the 3GPP access is not limited. Note that, in a case that the fourth rejected NSSAI is dependent on the access type, the UE and/or the NW desirably stores the fourth rejected NSSAI for each access type (that is, stores the fourth rejected NSSAI for each access type), but the present invention is not limited thereto.

In addition, in a case that the UE does not have any valid RA and/or TA, the fourth rejected NSSAI may be applicable to an RA and/or TA for which the rejected NSSAI has been received.

In addition, in a case that the current RA or the current TA in the current RA includes a Tracking Area Identity (TAI) belonging to a PLMN or SNPN different from the current PLMN or SNPN, and the PLMN or SNPN different from the current PLMN or SNPN are in an equivalent PLMN or equivalent SNPN relationship, the fourth rejected NSSAI may be applied to these PLMNs or SNPNs in the current RA and/or the current TA. In other words, in the current RA or the current TA, the fourth rejected NSSAI may be applied not only to the current PLMN or SNPN but also to the equivalent PLMN or equivalent SNPN.

In a case that the S-NSSAI that the UE includes in the requested NSSAI is the fourth rejected NSSAI, the AMF may reject the registration request message.

In addition, in a case that the 5GS registration type indicates mobility registration updating, that the purpose of initiating the registration procedure is not to change the network slice with which the UE is currently registered, and that the UE is in the current RA or the current TA, the UE may not include the requested NSSAI in the registration procedure.

In addition, the S-NSSAI included in the fourth rejected NSSAI (also referred to as “fourth rejected S-NSSAI”) may be associated with one or more TAs in which the rejected S-NSSAI (fourth rejected S-NSSAI) is not available.

In addition, in a case of being provided with new configured NSSAI for the current PLMN or SNPN, the UE may replace the stored configured NSSAI with the new configured NSSAI. In this case, the UE may further delete the mapped S-NSSAI for the stored configured NSSAI and store the mapped S-NSSAI for the new configured NSSAI, may further delete the stored fourth rejected NSSAI, or may further delete the S-NSSAI included in the mapped S-NSSAI for the new configured NSSAI for the current PLMN or SNPN, from the mapped S-NSSAI for the stored fourth rejected NSSAI.

In addition, in a case of receiving new allowed NSSAI for the current PLMN or SNPN, the UE may delete, from the stored fourth rejected NSSAI, the S-NSSAI included in the new allowed NSSAI. In this case, the UE may further delete, from the mapped S-NSSAI for the stored fourth rejected NSSAI, the S-NSSAI included in the mapped S-NSSAI for the new allowed NSSAI for the current PLMN or SNPN.

In addition, in a case of receiving the S-NSSAI (fourth rejected S-NSSAI) included in the rejected NSSAI (fourth rejected NSSAI) included in the registration accept message, or the registration reject message, or a de-registration request message, or a configuration update command message, the UE may store, based on the rejection cause, the received fourth rejected S-NSSAI in the rejected NSSAI and the mapped S-NSSAI for the rejected NSSAI, or in the fourth rejected NSSAI and the mapped S-NSSAI for the fourth rejected NSSAI, in the UE.

Further, in a case that the UE receives the S-NSSAI (fourth rejected S-NSSAI) included in the rejected NSSAI (fourth rejected NSSAI) included in the registration accept message, or the registration reject message, or the de-registration request message, or the configuration update command message, and the S-NSSAI is included in the Rejected NSSAI IE, the UE may delete the S-NSSAI (fourth rejected S-NSSAI) included in the fourth rejected NSSAI associated with the same access type, from the allowed NSSAI, stored in the UE, for the current PLMN or SNPN and the equivalent PLMN or equivalent SNPN of the current PLMN or SNPN.

Further, in a case that the UE receives, during non-roaming, the S-NSSAI (fourth rejected S-NSSAI) included in the rejected NSSAI (fourth rejected NSSAI) included in the registration accept message, or the registration reject message, or the de-registration request message, or the configuration update command message, and the S-NSSAI is included in the Extended rejected NSSAI IE, the UE may delete the S-NSSAI (fourth rejected S-NSSAI) included in the fourth rejected NSSAI associated with the same access type from the allowed NSSAI, stored in the UE, for the current PLMN or SNPN and the equivalent PLMN or equivalent SNPN of the current PLMN or SNPN.

Further, in a case that the UE receives, during roaming, the S-NSSAI (fourth rejected S-NSSAI) included in the rejected NSSAI (fourth rejected NSSAI) included in the registration accept message, or the registration reject message, or the de-registration request message, or the configuration update command message, and the S-NSSAI is included in the Extended rejected NSSAI IE, the UE may delete the S-NSSAI (fourth rejected S-NSSAI) included in the fourth rejected NSSAI associated with the same access type, from the allowed NSSAI, stored in the UE, for the current PLMN or SNPN and the equivalent PLMN or equivalent SNPN of the current PLMN or SNPN.

Further, in a case of receiving, during non-roaming, the S-NSSAI (fourth rejected S-NSSAI) included in the rejected NSSAI (fourth rejected NSSAI) included in the registration accept message, or the registration reject message, or the de-registration request message, or the configuration update command message, the UE may delete the S-NSSAI included in the mapped S-NSSAI for the fourth rejected NSSAI associated with the same access type, from the allowed NSSAI, stored in the UE, for the current PLMN or SNPN and the equivalent PLMN or equivalent SNPN of the current PLMN or SNPN.

Further, in a case of receiving, during roaming, the S-NSSAI (fourth rejected S-NSSAI) included in the rejected NSSAI (fourth rejected NSSAI) included in the registration accept message, or the registration reject message, or the de-registration request message, or the configuration update command message, the UE may delete the S-NSSAI included in the mapped S-NSSAI for the fourth rejected NSSAI associated with the same access type from the mapped S-NSSAI for the allowed NSSAI stored in the UE.

Further, in a case that the UE receives the S-NSSAI (fourth rejected S-NSSAI) included in the rejected NSSAI (fourth rejected NSSAI) included in the registration accept message, or the registration reject message, or the de-registration request message, or the configuration update command message, and the S-NSSAI is included in the Rejected NSSAI IE, the UE may delete the S-NSSAI (fourth rejected S-NSSAI) included in the fourth rejected NSSAI associated with the same access type, from the pending NSSAI, stored in the UE, for the current PLMN or SNPN and the equivalent PLMN or SNPN of the current PLMN or SNPN.

Further, in a case that the UE receives, during non-roaming, the S-NSSAI (fourth rejected S-NSSAI) included in the rejected NSSAI (fourth rejected NSSAI) included in the registration accept message, or the registration reject message, or the de-registration request message, or the configuration update command message, and the S-NSSAI is included in the Extended rejected NSSAI IE, the UE may delete the S-NSSAI (fourth rejected S-NSSAI) included in the fourth rejected NSSAI associated with the same access type, from the pending NSSAI, stored in the UE, for the current PLMN or SNPN and the equivalent PLMN or SNPN of the current PLMN or SNPN.

Further, in a case that the UE receives, during non-roaming, the S-NSSAI (the fourth rejected S-NSSAI) included in the rejected NSSAI (the fourth rejected NSSAI) included in the registration accept message, or the registration reject message, or the de-registration request message, or the configuration update command message, and the S-NSSAI is included in the Extended rejected NSSAI IE, the UE may delete the S-NSSAI included in the mapped S-NSSAI for the fourth rejected NSSAI associated with the same access type, from the pending NSSAI, stored in the UE, for the current PLMN or SNPN and the equivalent PLMN or SNPN of the current PLMN or SNPN.

Further, in a case that the UE receives, during roaming, the S-NSSAI (fourth rejected S-NSSAI) included in the rejected NSSAI (fourth rejected NSSAI) included in the registration accept message, or the registration reject message, or the de-registration request message, or the configuration update command message, and the S-NSSAI is included in the Extended rejected NSSAI IE, the UE may delete the S-NSSAI included in the mapped S-NSSAI for the fourth rejected NSSAI associated with the same access type, from the mapped S-NSSAI, stored in the UE, for the pending NSSAI.

In addition, in a case of deregistering over an access which is the access over which the UE receives the fourth rejected NSSAI or the fourth rejected S-NSSAI, in other words, in a case of completing a de-registration procedure over the access, the UE may delete the fourth rejected NSSAI and/or the access type of the fourth rejected NSSAI stored in the UE.

In addition, in a case of moving from the TA in which the fourth rejected NSSAI or the fourth rejected S-NSSAI has been received to another TA, the UE may delete the fourth rejected NSSAI and/or the access type thereof stored in the UE.

In a case of transitioning from the 5GMM-REGISTERED state to the 5GMM-DEREGISTERED state or transitioning from the 5GMM-DEREGISTERED state to the 5GMM-REGISTERED state, the UE may delete the fourth rejected NSSAI stored in the UE and/or the access type of the fourth rejected NSSAI stored in the UE.

In a case of receiving the fourth rejected NSSAI included in the registration accept message, the registration reject message, the configuration update command message, or the de-registration request message, the UE may perform an operation based on the rejection cause included in the rejected S-NSSAI (fourth rejected S-NSSAI) included in the fourth rejected NSSAI. Specifically, in a case that the rejection cause included in the rejected S-NSSAI indicates “S-NSSAI not available in the current TA” and/or “S-NSSAI not available in the current TA in the current RA” and/or “No network slices (NSs) available”, the UE may be forbidden from using the fourth S-NSSAI in the current TA. In other words, the UE may be in a state of being forbidden from initiating the MM procedure and/or the SM procedure using the fourth S-NSSAI in the current TA.

Note that, in a case that the UE is powered off, that the UE moves out of the current TA, that the UICC including the USIM is removed from the UE, or that the fourth rejected NSSAI or the fourth rejected S-NSSAI stored in the UE is deleted, the regulation may be canceled. In other words, the UE may be in a state of being allowed to perform the MM procedure and/or the SM procedure using the fourth S-NSSAI in the current TA.

In a case of transmitting the registration request message including the requested NSSAI, the UE may select the S-NSSAI included in the requested NSSAI from among the stored pieces of S-NSSAI other than the S-NSSAI included in the fourth rejected NSSAI (the fourth rejected S-NSSAI) and/or the S-NSSAI included in the mapped S-NSSAI for the fourth rejected NSSAI.

In addition, in a case that the UE transmits a registration request message including capability information indicating that the NSSAA is not supported and the requested NSSAI and that the S-NSSAI included in the requested NSSAI is S-NSSAI related to NSSAA, the AMF may transmit a registration accept message including rejected NSSAI including the S-NSSAI and a rejection cause indicating “S-NSSAI not available in the current tracking area (TA)” and/or “S-NSSAI not available in the current tracking area (TA) in the current registration area (RA)” and/or “No network slices (NSs) available”.

The fourth rejected S-NSSAI may be not only rejected S-NSSAI included in the fourth rejected NSSAI but also rejected S-NSSAI not included in the fourth rejected NSSAI. The above description related to the fourth rejected NSSAI may be interpreted as the description related to the fourth rejected S-NSSAI.

The fourth rejected NSSAI and the fourth rejected S-NSSAI may be included as the LADN information included in the registration accept message or the configuration update command and notified from the core network side to the UE.

The mapped S-NSSAI for the fourth rejected NSSAI may be the mapped S-NSSAI corresponding to the fourth rejected NSSAI. In other words, the mapped S-NSSAI for the fourth rejected NSSAI may be S-NSSAI for the HPLMN mapped to the S-NSSAI for a registered PLMN (that is, S-NSSAI included in the fourth rejected NSSAI, or fourth rejected S-NSSAI) in a roaming scenario.

The mapped S-NSSAI for the fourth rejected NSSAI may be valid for the 3GPP access and/or non-3GPP access. In other words, the UE and/or the NW may handle the mapped S-NSSAI for the fourth rejected NSSAI as that not dependent on the access type, or may handle the mapped S-NSSAI for the fourth rejected NSSAI as that dependent on the access type. In still other words, the UE and/or the NW may manage and/or store the mapped S-NSSAI for the fourth rejected NSSAI for each access type, or need not manage and/or store the mapped S-NSSAI for the fourth rejected NSSAI for each access type.

Here, the fact that the mapped S-NSSAI for the fourth rejected NSSAI is not dependent on the access type may mean that, for example, in a case that the UE receives the mapped S-NSSAI for the fourth rejected NSSAI via the 3GPP access, the mapped S-NSSAI for the fourth rejected NSSAI is not only unavailable via the 3GPP access but also unavailable via the non-3GPP access. Similarly, in a case that the UE receives the mapped S-NSSAI for the fourth rejected NSSAI via the non-3GPP access, this may mean that the mapped S-NSSAI for the fourth rejected NSSAI is not only unavailable via the 3GPP access but also unavailable via the non-3GPP access. Note that, in a case that the mapped S-NSSAI for the fourth rejected NSSAI is not dependent on the access type, the UE and/or the NW desirably does not store the mapped S-NSSAI for the fourth rejected NSSAI for each access type (that is, does not store the mapped S-NSSAI for the fourth rejected NSSAI separately for each access type but simply stores the fourth rejected NSSAI), but the present invention is not limited thereto.

In addition, the case where the mapped S-NSSAI for the fourth rejected NSSAI is dependent on the access type may mean that, for example, in a case that the UE receives the mapped S-NSSAI for the fourth rejected NSSAI via the 3GPP access, the mapped S-NSSAI for the fourth rejected NSSAI is unavailable via the 3GPP access, but need not mean that, in this case, the mapped S-NSSAI for the fourth rejected NSSAI is unavailable via the non-3GPP access. In other words, this may mean that the use of the mapped S-NSSAI for the fourth rejected NSSAI via the non-3GPP access is not limited. Similarly, in a case that the UE receives the mapped S-NSSAI for the fourth rejected NSSAI via the non-3GPP access, this may mean that the mapped S-NSSAI for the fourth rejected NSSAI is unavailable via the non-3GPP access, but need not mean that the mapped S-NSSAI for the fourth rejected NSSAI is unavailable via the 3GPP access. In other words, this may mean that the use of the mapped S-NSSAI for the fourth rejected NSSAI via the 3GPP access is not limited. Note that, in a case that the mapped S-NSSAI for the fourth rejected NSSAI is dependent on the access type, the UE and/or the NW desirably stores the mapped S-NSSAI for the fourth rejected NSSAI for each access type (that is, stores the fourth rejected NSSAI for each access type), but the present invention is not limited thereto.

In addition, the fourth rejected NSSAI, and/or the fourth rejected S-NSSAI, and/or the S-NSSAI included in the mapped S-NSSAI for the fourth rejected NSSAI in the storage unit of the UE may be handled as unavailable in the current TA or in the current TA in the current RA. In other words, the UE may be in a state of being forbidden from initiating the MM procedure and/or the SM procedure using the S-NSSAI in the current TA or in the current TA in the current RA. In other words, the UE may be in a state of being forbidden from initiating the MM procedure and/or the SM procedure using the S-NSSAI in a TA other than in the current TA or in a TA other than the current TA in the current RA.

The pending NSSAI (also referred to as Pending NSSAI) is one piece or a set of multiple pieces of S-NSSAI that require network slice specific authentication by the network, for which the network slice specific authentication has not completed yet, and that are not available in the current PLMN.

The pending NSSAI may be a Rejected NSSAI due to NSSAA or a pending NSSAI of the 5GS. The pending NSSAI may be NSSAI stored by the UE or the NW and may be NSSAI transmitted from the NW to the UE. Note that the pending NSSAI is not limited to the rejected NSSAI and may be NSSAI independent of the rejected NSSAI. In a case that the pending NSSAI is NSSAI transmitted from the NW to the UE, the pending NSSAI may be information including one or multiple combinations of S-NSSAI and a reject cause value. The reject cause value in this case may be “S-NSSAI pending for NSSAA (NSSAA is pending for the S-NSSAI)” or may be information indicating that the UE is forbidden from or pending using the S-NSSAI associated with the reject cause value until NSSAA for the S-NSSAI completes.

The pending NSSAI is valid in the entire registered PLMN. In other words, the UE and/or the NW may treat the third rejected NSSAI and the S-NSSAI included in the pending NSSAI as information not dependent on the access type. In other words, the pending NSSAI may be information valid for 3GPP access and non-3GPP access. The pending NSSAI may be NSSAI different from the rejected NSSAI. The pending NSSAI may be the second or fourth rejected NSSAI.

The pending NSSAI is the NSSAI including one or multiple pieces of S-NSSAI allowing the UE to identify the slice in which the procedure is pending. Specifically, while storing the pending NSSAI, the UE does not initiate the registration request procedure for the S-NSSAI included in the pending NSSAI. In other words, the UE does not use the S-NSSAI included in the pending NSSAI during the registration procedure until NSSAA for the S-NSSAI included in the pending NSSAI is completed. The pending NSSAI is identification information including one or multiple pieces of S-NSSAI received from the core network in association with the reject cause value indicating pending for NSSAA. The pending NSSAI is information regardless of the access type. Specifically, in a case that the UE stores the pending NSSAI, the UE does not attempt to transmit, either on 3GPP access or on non-3GPP access, a registration request message including the S-NSSAI included in the pending NSSAI.

A tracking area (also referred to as a “TA”) is a single or multiple ranges that can be expressed using location information of the UE_A 10 managed by the core network. A TA may include multiple cells. Furthermore, a TA may be a range in which a control message of paging, or the like is broadcast, or a range in which the UE_A 10 can move without performing a handover procedure. Furthermore, a TA may be a routing area, may be a location area, or may be any area similar to these. A TA may be identified by a Tracking Area Identity (TAI) including a PLMN Identifier (PLMN ID) and a Tracking Area Code (TAC). Here, the PLMN ID is an identifier used to identify the PLMN and may include a Mobile Country Code (MCC) and a Mobile Network Code (MNC). The MCC is an identifier used to identify the country in which the UE is located, and the MNC is an identifier used to identify an HPLMN in the country in which the UE is located. In addition, the TAC is an identifier used to identify a TA in the PLMN.

A registration area (also referred to as an “RA”) is one TA or a set of multiple TAs allocated to the UE by the AMF. Note that, while moving within one or multiple TAs included in an RA, the UE_A 10 may be able to move without transmitting and/or receiving a signal for updating the TA. In other words, the RA may be an information group indicating an area in which the UE_A 10 can move without performing the TA updating procedure. The RA may be identified with a TAI list including one or multiple TAIs.

A UE ID is information for identifying the UE. Specifically, the UE ID may be a SUbscription Concealed Identifier (SUCI), or a Subscription Permanent Identifier (SUPI), or a Globally Unique Temporary Identifier (GUTI), or an International Mobile Subscriber Identity (IMEI), or an IMEI Software Version (IMEISV), or a Temporary Mobile Subscriber Identity (TMSI), for example. Alternatively, the UE ID may be other information configured by an application or within the network. Moreover, the UE ID may be information for identifying the user.

Network Slice-Specific Authentication and Authorization (NSSAA) is a function for implementing network slice specific authentication and authorization. The network slice-specific authentication and authorization allows the UE to be authenticated and authorized outside the core network, such as in a 3rd Party. The PLMN and the network apparatus having the NSSAA function can perform a NSSAA procedure for certain S-NSSAI, based on registration information of the UE. Furthermore, the UE having the NSSAA function can manage and store the rejected NSSAI for pending for NSSAA and/or the rejected NSSAI for failure of NSSAA. In the present document, NSSAA may be referred to as a network slice-specific authentication and authorization procedure or an authentication and authorization procedure.

The S-NSSAI that requires NSSAA is S-NSSAI that requires NSSAA managed by the core network and/or the core network apparatus. The core network and/or the core network apparatus may store the S-NSSAI that requires NSSAA by associating the S-NSSAI with information indicating whether NSSAA is required. Furthermore, the core network and/or the core network apparatus may store the S-NSSAI requiring the NSSAA in association with information indicating whether NSSAA has completed or information indicating that NSSAA has completed and been allowed or succeeded. The core network and/or the core network apparatus may manage the S-NSSAI requiring NSSAA as information unrelated to the access network.

The UE in a single registration mode has only one active MM state. In other words, the UE in the single registration mode is active only in either the RM state (5GMM state) in the 5GC or the EMM state in the EPC. The UE in the single registration mode is in a 5GC NAS mode in a case of connecting to the 5GC, and is in an EPC NAS mode in a case of connecting to the EPC. The UE in the single registration mode can be registered with only either the 5GC or the EPC, and thus needs to perform mapping between an EPS-GUTI (also referred to as a 4G-GUTI) and a 5G-GUTI in movement between the EPC and the 5GC.

The UE in a dual registration mode may be in a state in which the UE can be independently registered with the 5GC and the EPC. The UE in the dual registration mode can independently maintain the 5G-GUTI and the EPS-GUTI (also referred to as a 4G-GUTI).

The SNPN is a type of NPN being a 5GS deployed for non-public use and is an NPN that is operated by an NPN operator and that is not dependent on the NF provided by the PLMN. The SNPN is identified by a combination of a PLMN ID and a Network Identifier (NID). The UE that can use the SNPN may support an SNPN access mode (also referred to as an SNPN access operation mode). The UE configured to operate in the SNPN access mode may be able to select the SNPN and be registered with the SNPN or need not be able to select the PLMN. The UE configured to operate in the SNPN access mode may be able to perform an SNPN selection procedure or need not be able to perform a PLMN selection procedure. The UE that is not configured to operate in the SNPN access mode although the UE can use the SNPN (SNPN enabled) need not be able to select the SNPN and be registered with the SNPN or may be able to select the PLMN. The UE that is not configured to operate in the SNPN access mode need not be able to perform the SNPN selection procedure, or may be able to perform the PLMN selection procedure.

The UE operating in the SNPN access mode may be able to select the SNPN via Uu (3GPP access). The UE operating in the SNPN access mode may be able to select the SNPN via Uu or NWu established via a PDU session provided by the PLMN selected via Uu or NWu (non-3GPP access). The UE not operating in the SNPN access mode may be able to select the PLMN via Uu or NWu established via a PDU session provided by the SNPN selected via Uu or NWu (non-3GPP access).

Note that the SNPN access mode may be managed and/or applied in each access. In other words, the SNPN access mode may be managed and/or applied separately for 3GPP access and non-3GPP access. In other words, activation or deactivation of the SNPN access mode for 3GPP access and activation or deactivation of the SNPN access mode for non-3GPP access may be independent of each other. In other words, in a case that the SNPN access mode for 3GPP access is activated, the SNPN access mode for non-3GPP access may be activated or may be deactivated. In a case that the SNPN access mode for 3GPP access is deactivated, the SNPN access mode for non-3GPP access may be activated or may be deactivated.

Here, the SNPN access mode for 3GPP access may also be referred to as the SNPN access mode over 3GPP access or the SNPN access mode via 3GPP access.

The SNPN access mode for non-3GPP access may be referred to as the SNPN access mode over non-3GPP access or the SNPN access mode via non-3GPP access.

“To activate” may be interpreted as “to operate”, and “to deactivate” may be interpreted as “not to operate”. In other words, activation of the SNPN access mode for 3GPP access may mean to operate in the SNPN access mode for 3GPP access. Deactivation of the SNPN access mode for 3GPP access may mean not to operate in the SNPN access mode for 3GPP access. Activation of the SNPN access mode for non-3GPP access may mean to operate in the SNPN access mode for non-3GPP access. Deactivation of the SNPN access mode for non-3GPP access may mean not to operate in the SNPN access mode for non-3GPP access.

In a case that the UE roams between SNPNs, the SNPNs may be classified into a Home SNPN (also referred to as an HSNPN) and a Visited SNPN (also referred to as a VSNPN). Note that, in a case that the UE does not roam between the SNPNs, the SNPNs may be handled as being the same as the Home SNPN.

The Home SNPN may be an SNPN in which the UE can be registered as a home. The Home SNPN may be an SNPN that the UE selects first in SNPN selection. The Home SNPN may be an SNPN in which at least a part of information included in an SNPN identity (also referred to as an SNPN ID) matches at least a part of information included in an IMSI of the UE. The Home SNPN may be an SNPN in which the MCC and the MNC included in a PLMN Identity (also referred to as a PLMN ID) included in an SNPN identity (also referred to as an SNPN ID) match the MCC and the MNC included in the IMSI of the UE.

The Visited SNPN may be an SNPN in which the UE can be registered as other than a home. The Visited SNPN may be an SNPN in which the UE is not registered as a home. The Visited SNPN may be an SNPN that the UE does not select first in SNPN selection. The Visited SNPN may be an SNPN in which at least a part of information included in the SNPN identity (also referred to as an SNPN ID) does not match at least a part of information included in the IMSI of the UE. The Visited SNPN may be an SNPN in which the MCC and the MNC included in the PLMN Identity (also referred to as a PLMN ID) included in the SNPN identity (also referred to as an SNPN ID) do not match the MCC and the MNC included in the IMSI of the UE.

An equivalent HSNPN (also referred to as an equivalent Home SNPN or an EHSNPN) may be an SNPN considered to be equivalent to the current SNPN (here, the Home SNPN (also referred to as an HSNPN)) in SNPN selection, and/or cell selection, and/or cell reselection. The equivalent HSNPN may be one or more SNPNs included in an equivalent HSNPN list or may be one or more SNPNs not included in an equivalent VSNPN list.

An equivalent VSNPN (also referred to as an equivalent Visited SNPN or an EVSNPN) may be an SNPN considered to be equivalent to the current SNPN (here, the Visited SNPN (also referred to as a VSNPN)) in SNPN selection, and/or cell selection, and/or cell reselection. The equivalent VSNPN may be one or more SNPNs included in the equivalent VSNPN list or may be one or more SNPNs not included in the equivalent HSNPN list.

An equivalent SNPN (also referred to as an ESNPN) may be a concept including the equivalent HSNPN and/or the equivalent VSNPN. In other words, the ESNPN may indicate the equivalent HSNPN and/or the equivalent VSNPN.

The SNPN with which the UE has been successfully registered may be a Registered SNPN (also referred to as a registered SNPN) (RSNPN).

In addition, partially allowed NSSAI (also referred to as “partially allowed NSSAI or partially allowed NSSAI IE”) may be NSSAI including one or more pieces of S-NSSAI that are available for the UE in some TAs in the current RA. In addition, the partially allowed NSSAI may be managed as a part of the allowed NSSAI, or may be managed separately from the allowed NSSAI. In addition, the partially allowed NSSAI may be managed as rejected NSSAI or may be managed separately from rejected NSSAI. In addition, the partially allowed NSSAI may be managed in association with the S-NSSAI rejected partially in the current RA. That is, the S-NSSAI included in the partially allowed NSSAI may be managed not to be included in the S-NSSAI rejected partially in the current RA, or the S-NSSAI included in the S-NSSAI rejected partially in the current RA may be managed not to be included in the partially allowed NSSAI.

In addition, the S-NSSAI included in the partially allowed NSSAI may be associated with the TA list that supports the S-NSSAI. In other words, in a case that one or more pieces of S-NSSAI are included in the partially allowed NSSAI, the TA list in which the S-NSSAI is supported (available) may be associated with each piece of S-NSSAI. Further, in other words, in a case that the network (e.g., the AMF or SMF) transmits, to the UE, the partially allowed NSSAI including one or more pieces of S-NSSAI, the network may transmit, for each piece of S-NSSAI, the partially allowed NSSAI together with the TA list in which the S-NSSAI is supported (available). At this time, the TA list may be included in the partially allowed NSSAI and transmitted, or may be transmitted as information different from the partially allowed NSSAI. Furthermore, in a case that the UE is roaming, the network (for example, the AMF or SMF) may transmit, to the UE, the mapped NSSAI (NSSAI including one or more pieces of mapped S-NSSAI) corresponding to the partially allowed NSSAI or the S-NSSAI included in the partially allowed NSSAI or the mapped S-NSSAI (S-NSSAI of the HPLMN) in addition to the above.

Furthermore, for each partially allowed NSSAI and/or S-NSSAI, the TA list in which the S-NSSAI is supported (available) and/or the mapped NSSAI or the mapped S-NSSAI corresponding to the partially allowed NSSAI or the S-NSSAI included in the partially allowed NSSAI may be control information transmitted and/or received from the network (for example, the AMF) to the UE in an MM message (for example, a registration accept message and/or a configuration update command).

In addition, S-NSSAI rejected partially in the current RA (also referred to as S-NSSAI partially rejected in the current RA) may be S-NSSAI that is not available for the UE in some TAs in the current RA. In addition, S-NSSAI rejected partially in the current RA may be the second or fourth rejected S-NSSAI, or the second or fourth rejected NSSAI. In addition, the S-NSSAI rejected partially in the current RA may be stored as the S-NSSAI rejected partially in the current RA, may be stored as the second or fourth rejected S-NSSAI, may be stored by being included in the second or fourth rejected NSSAI, or may be stored as the second or fourth rejected NSSAI in the UE and/or the AMF.

In addition, the S-NSSAI rejected partially in the current RA may be associated with a TA list in which the S-NSSAI is supported (available) and/or a TA list in which the S-NSSAI is not supported (unavailable). In other words, in a case that one or more pieces of S-NSSAI are included in the S-NSSAI rejected partially in the current RA, a TA list in which S-NSSAI is supported and/or a TA list in which S-NSSAI is not supported may be associated with each piece of S-NSSAI. Furthermore, in other words, in a case that the network (e.g., the AMF or SMF) transmits and/or receives the S-NSSAI rejected partially in the current RA including one or more pieces of S-NSSAI to and/or from the UE, the network may transmit and/or receive the S-NSSAI together with a TA list in which S-NSSAI is supported and/or a TA list in which S-NSSAI is not supported for each piece of S-NSSAI. At this time, these TA lists may be transmitted and/or received in a state of being included in the S-NSSAI rejected partially in the current RA, or may be transmitted and/or received as information different from the S-NSSAI rejected partially in the current RA.

In addition, the S-NSSAI rejected partially in the current RA, and/or the TA list in which S-NSSAI is supported, and/or the TA list in which S-NSSAI is not supported may be control information transmitted and/or received from the network (e.g., the AMF) to the UE in an MM message (e.g., a registration accept message and/or a configuration update command).

Furthermore, for each piece of partially allowed NSSAI and/or S-NSSAI, the TA list in which S-NSSAI is supported (available) and/or the mapped NSSAI or the mapped S-NSSAI corresponding to the partially allowed NSSAI or the S-NSSAI included in the partially allowed NSSAI may be applied to the PLMN or may be applicable to the SNPN.

Furthermore, the S-NSSAI rejected partially in the current RA, and/or the TA list in which S-NSSAI is supported, and/or the TA list in which S-NSSAI is not supported may be applied to the PLMN, or may be applicable to the SNPN.

### 3. First Embodiment

First, a first embodiment will be described. In the present embodiment, control information transmitted and/or received and stored and/or managed by each apparatus/function will be described.

Note that, in the first embodiment, as illustrated in FIG. 2, a case will be described as an example in which the HSS and the UDM, the PCF and the PCRF, the SMF and the PGW-C, and the UPF and the PGW-U are each implemented as the same apparatus/function (that is, as the same physical hardware, logical hardware, or software). However, the details described in the present embodiment can also be applied to a case that each of the combinations is implemented as different apparatuses/functions (that is, different pieces of physical hardware, or different pieces of logical hardware, or different pieces of software). For example, between the apparatuses/functions, data may be directly transmitted and/or received, data may be transmitted and/or received via an N26 interface between the AMF and the MME, or data may be transmitted and/or received via the UE.

First, the UE and/or the network may have a capability of processing the functionality for the partially allowed NSSAI, and/or the S-NSSAI rejected partially in the current RA, and/or the second or fourth rejected S-NSSAI, or the second or fourth rejected NSSAI, and/or the partial network slice, and/or the partial network slice in the RA.

The UE having the above capability may transmit an MM message (e.g., a registration request message) and/or an SM message (e.g., a PDU session establishment request message) including information indicating that the UE has a capability of processing the functionality for the partially allowed NSSAI, and/or the S-NSSAI rejected partially in the current RA, and/or the second or fourth rejected S-NSSAI, or the second or fourth rejected NSSAI, and/or the partial network slice, and/or the partial network slice in the RA.

In addition, the network having the above capability may transmit an MM message (e.g., a registration accept message) and/or an SM message (e.g., a PDU session establishment accept message) including information indicating that the UE has a capability of processing the partially allowed NSSAI, and/or the S-NSSAI rejected partially in the current RA, and/or the second or fourth rejected S-NSSAI, or the second or fourth rejected NSSAI, and/or the partial network slice, and/or the partial network slice functionality in the RA.

In addition, in a case that the UE is storing certain S-NSSAI in the partially allowed NSSAI, and receives NSSAI including the S-NSSAI (any of allowed NSSAI, pending NSSAI, rejected NSSAI, configured NSSAI, and default configured NSSAI), the UE may delete the S-NSSAI from the stored partially allowed NSSAI. Then, the UE may store the S-NSSAI in the NSSAI corresponding to the received NSSAI. For example, in a case that the UE is storing certain S-NSSAI in the partially allowed NSSAI, and receives the allowed NSSAI including the S-NSSAI, the UE may delete the S-NSSAI from the partially allowed NSSAI for the UE and store the S-NSSAI in the allowed NSSAI for the UE.

In addition, in a case that the UE is storing certain S-NSSAI in the partially allowed NSSAI, and in a case that the UE receives the S-NSSAI rejected partially in the current RA corresponding to the S-NSSAI, the second or fourth rejected S-NSSAI corresponding to the S-NSSAI, or the second or fourth rejected NSSAI including the S-NSSAI, then the UE may remove the S-NSSAI from the partially allowed NSSAI in the UE. Moreover, the UE may store the S-NSSAI in the S-NSSAI rejected partially in the current RA in the UE, the second or fourth rejected S-NSSAI in the UE, or the second or fourth rejected NSSAI in the UE, based on the received S-NSSAI rejected partially in the current RA, the received second or fourth rejected S-NSSAI, or the received second or fourth rejected NSSAI.

In addition, in a case that the UE is storing certain S-NSSAI in the partially allowed NSSAI, the UE may delete the S-NSSAI from the stored partially allowed NSSAI in a case that the UE moves out of the current RA.

Then, the UE may delete the TA list in which the S-NSSAI is supported (available), together with the S-NSSAI from the partially allowed NSSAI. Furthermore, the UE may delete the mapped NSSAI (NSSAI including one or more pieces of mapped S-NSSAI) or the mapped S-NSSAI (S-NSSAI of the HPLMN) corresponding to the S-NSSAI.

Furthermore, in a case that the UE has deleted the S-NSSAI from the partially allowed NSSAI, and/or deleted the TA list in which the S-NSSAI is supported, and/or deleted the mapped NSSAI or the mapped S-NSSAI corresponding to the S-NSSAI, the UE may not change the recognition of being registered in the entire current RA, may recognize that the registration in the entire current RA using the S-NSSAI has been canceled, or may recognize that the registration in the entire current RA has been canceled.

In addition, in a case that the UE has deleted the S-NSSAI from the partially allowed NSSAI, and/or deleted the TA list in which the S-NSSAI is supported, and/or deleted the mapped NSSAI or the mapped S-NSSAI corresponding to the S-NSSAI, in a case that the S-NSSAI is included in the allowed NSSAI, the UE may recognize that the S-NSSAI has been registered in the current RA, or may recognize that the registration in the entire current RA has been canceled in a case that the S-NSSAI is included in the rejected NSSAI.

In addition, in a case that a PDU session using the S-NSSAI is established in a TA in which the S-NSSAI is supported in the current RA, in a case that the UE has deleted the S-NSSAI from the partially allowed NSSAI, and/or deleted the TA list in which the S-NSSAI is supported, and/or deleted the mapped NSSAI or the mapped S-NSSAI corresponding to the S-NSSAI, the UE and/or the network may release the PDU session and/or UP resources of the PDU session.

In addition, in a case that a PDU session using the S-NSSAI is established in a TA in which the S-NSSAI is supported in the current RA and UP resources of the PDU session are deactivated, in a case that the UE has deleted the S-NSSAI from the partially allowed NSSAI, and/or deleted the TA list in which the S-NSSAI is supported, and/or deleted the mapped NSSAI or the mapped S-NSSAI corresponding to the S-NSSAI, the UE and/or the network may activate the UP resources of the PDU session or keep deactivating them.

In addition, in a case that a PDU session using the S-NSSAI is established in a TA in which the S-NSSAI is supported in the current RA and UP resources of the PDU session are activated, in a case that the UE has deleted the S-NSSAI from the partially allowed NSSAI, and/or deleted the TA list in which the S-NSSAI is supported, and/or deleted the mapped NSSAI or the mapped S-NSSAI corresponding to the S-NSSAI, the UE and/or the network may deactivate the UP resources of the PDU session or keep activating them.

In addition, in a case that the UE is storing certain S-NSSAI in the S-NSSAI rejected partially in the current RA, the second or fourth rejected S-NSSAI, or the second or fourth rejected NSSAI, and receives the NSSAI including the S-NSSAI (any of the allowed NSSAI, the pending NSSAI, the rejected NSSAI, the configured NSSAI, the default configured NSSAI, and the partially allowed NSSAI), the UE may delete the S-NSSAI from the stored S-NSSAI rejected partially in the current RA, the second or fourth rejected S-NSSAI, or the second or fourth rejected NSSAI. Then, the UE may store the S-NSSAI in the NSSAI corresponding to the received NSSAI. For example, in a case that the UE is storing certain S-NSSAI in the S-NSSAI rejected partially in the current RA, or the second or fourth rejected S-NSSAI, or the second or fourth rejected NSSAI, and in a case of receiving the partially allowed NSSAI including the S-NSSAI, the UE may delete the S-NSSAI from the S-NSSAI rejected partially in the current RA, or the second or fourth rejected S-NSSAI, or the second or fourth rejected NSSAI for the UE, and may store the S-NSSAI in the partially allowed NSSAI for the UE.

In addition, in a case that the UE is storing certain S-NSSAI in the S-NSSAI rejected partially in the current RA, the second or fourth rejected S-NSSAI, or the second or fourth rejected NSSAI, and in a case that the UE moves out of the current RA, the UE may delete the S-NSSAI from the stored S-NSSAI rejected partially in the current RA, the second or fourth rejected S-NSSAI, or the second or fourth rejected NSSAI.

Then, the UE may delete the S-NSSAI, and may delete the TA list in which the S-NSSAI is supported and/or the TA list in which the S-NSSAI is not supported.

Furthermore, in a case that the UE has deleted the S-NSSAI from the S-NSSAI rejected partially in the current RA, the second or fourth rejected S-NSSAI, or the second or fourth rejected NSSAI, and/or deleted the TA list in which the S-NSSAI is supported and/or the TA list in which the S-NSSAI is not supported, the UE may recognize that the S-NSSAI stored in the S-NSSAI rejected partially in the current RA, the second or fourth rejected S-NSSAI, or the second or fourth rejected NSSAI can be used in the TA list in which the S-NSSAI is not supported.

In addition, in a case that the UE has (is storing) the partially allowed NSSAI and the UE is in a TA in which the S-NSSAI included in the partially allowed NSSAI is supported, the UE may transmit the S-NSSAI included in the requested NSSAI (also referred to as “a requested NSSAI Information Element (IE)) in the registration request message.

In addition, in a case that the UE does not have (is not storing) the allowed NSSAI for the current PLMN or SNPN and/or the configured NSSAI for the current PLMN or SNPN and/or the default configured NSSAI, and in a case that the UE has (is storing) the partially allowed NSSAI and is in the TA in which the S-NSSAI included in the partially allowed NSSAI is supported, the UE may transmit the S-NSSAI included in the requested NSSAI in the registration request message.

In addition, in a case that the UE has (is storing) the S-NSSAI rejected partially in the current RA, the second or fourth rejected S-NSSAI, or the second or fourth rejected NSSAI, and in a case that the UE is in a TA (also referred to as a “TA included in the TA list”) in which the S-NSSAI included in the S-NSSAI rejected partially in the current RA, the second or fourth rejected S-NSSAI, or the second or fourth rejected NSSAI is supported, or is not in a TA in which the S-NSSAI is not supported, the UE may transmit the S-NSSAI included in the requested NSSAI in the registration request message.

In addition, in a case that the UE does not have (is not storing) the allowed NSSAI for the current PLMN or SNPN, and/or the configured NSSAI for the current PLMN or SNPN, and/or default configured NSSAI, and in a case that the UE has (is storing) the S-NSSAI rejected partially in the current RA, the second or fourth rejected S-NSSAI, or the second or fourth rejected NSSAI, and the UE is in a TA in which the S-NSSAI included in the S-NSSAI rejected partially in the current RA, the second or fourth rejected S-NSSAI, or the second or fourth rejected NSSAI is supported, or is not in a TA in which the S-NSSAI is not supported, the UE may transmit the S-NSSAI included in the requested NSSAI in the registration request message.

In addition, in a case of including the S-NSSAI included in the partially allowed NSSAI in the requested NSSAI in the registration request message, the UE may include information indicating that the requested NSSAI is created from the partially allowed NSSAI in the registration request message and/or the requested NSSAI.

In addition, in a case of including the S-NSSAI rejected partially in the current RA, the second or fourth rejected S-NSSAI, or the S-NSSAI included in the second or fourth rejected NSSAI in the requested NSSAI in the registration request message, the UE may include information indicating that the requested NSSAI has been created from the S-NSSAI rejected partially in the current RA, the second or fourth rejected S-NSSAI, or the second or fourth rejected NSSAI in the requested NSSAI, and/or the registration request message including the requested NSSAI, and/or the NAS message including the registration request message.

In addition, in a case that the UE does not have (is not storing) the allowed NSSAI for the current PLMN or SNPN, and/or the configured NSSAI for the current PLMN or SNPN, and/or the default configured NSSAI, and/or the partially allowed NSSAI, and/or the S-NSSAI rejected partially in the current RA, or the second or fourth rejected S-NSSAI, or the second or fourth rejected NSSAI, the UE may not include the requested NSSAI in the registration request message.

In addition, in a case that the UE does not have (is not storing) the allowed NSSAI for the current PLMN or SNPN, and/or the configured NSSAI for the current PLMN or SNPN, and/or the default configured NSSAI, but has (is storing) the partially allowed NSSAI, and/or the S-NSSAI rejected partially in the current RA, the second or fourth rejected S-NSSAI, or the second or fourth rejected NSSAI, or in a case that the UE is not in a TA in which the S-NSSAI is supported or in a TA in which the S-NSSAI is not supported, the UE may not include the requested NSSAI in the registration request message.

In addition, in a case that the UE does not have (is not storing) the allowed NSSAI for the current PLMN or SNPN, and/or the configured NSSAI for the current PLMN or SNPN, and/or the partially allowed NSSAI, and/or the S-NSSAI rejected partially in the current RA, the second or fourth rejected S-NSSAI, or the second or fourth rejected NSSAI, but has (is storing) the default configured NSSAI, the UE may include the S-NSSAI included in the default configured NSSAI in the requested NSSAI in the registration request message.

Further, the S-NSSAI included in the partially allowed NSSAI may be or may not be a target of session management-based Network slice admission control (NSAC). In other words, the network may determine whether to apply the session management-based NSAC to each piece of S-NSSAI for the S-NSSAI included in the partially allowed NSSAI.

In addition, in a case that the UE has established a PDU session in a TA in which the S-NSSAI included in the partially allowed NSSAI is supported and the core network (e.g., the AMF, SMF, NSSF, or PCF) has detected that the UE has moved to a TA in which the S-NSSAI is not supported, the AMF or SMF may notify the NSACF that the S-NSSAI is not supported in the TA, and/or the S-NSSAI is partially unavailable in the current RA, and/or the S-NSSAI is unavailable in the current TA, and/or the S-NSSAI is partially unavailable in the current RA, and/or the S-NSSAI is available in another TA, and/or the S-NSSAI is available in another TA of the current RA. Furthermore, even if the NSACF receives these pieces of information, it may not change (increase or decrease) the count of the number of PDU sessions for the S-NSSAI.

Thereafter, the NSACF may transmit, to the AMF and/or SMF, information indicating that the count of the number of PDU sessions for the S-NSSAI has not been changed. At this time, the SMF may not release the PDU session and/or the UP resources for the PDU session, or may deactivate the UP resources for the PDU session. Furthermore, in a case that the core network (e.g., the AMF or SMF or NSSF or PCF) detects that the UE has moved to a TA in which the S-NSSAI is supported, the AMF or SMF may notify the NSACF that the S-NSSAI is supported in the TA, and/or the S-NSSAI is partially available in the current RA, and/or the S-NSSAI is available in the current TA, and/or the S-NSSAI is partially available in the current RA, and/or the S-NSSAI is not available in another TA, and/or the S-NSSAI is not available in another TA of the current RA. Furthermore, even if the NSACF receives these pieces of information, it may not change (increase or decrease) the count of the number of PDU sessions for the S-NSSAI. Thereafter, the NSACF may transmit, to the AMF and/or SMF, information indicating that the count of the number of PDU sessions for the S-NSSAI has not been changed. At this time, the SMF may not release the PDU session and/or the UP resources for the PDU session, or may activate the UP resources for the PDU session.

In addition, in a case that the UE transmits a NAS message including a PDU session establishment request message using the S-NSSAI in the TA in which the S-NSSAI included in the partially allowed NSSAI is not supported, in a case that the AMF receives the NAS message including the PDU session establishment request message and the AMF detects that the S-NSSAI is not supported in the TA and/or the S-NSSAI is not partially available in the current RA, the AMF may transfer the PDU session establishment request message to the SMF and notify the SMF of the S-NSSAI and/or that the S-NSSAI is not supported in the TA and/or the S-NSSAI is not partially available in the current RA. Here, the detection by the AMF may be performed by itself, or may be acquired from another NF (e.g., NSSF or PCF). Then, the SMF that has received these pieces of control information may transmit a PDU session establishment reject message to the UE via the AMF. At this time, the SMF may include the S-NSSAI and/or the cause value in the PDU session establishment reject message. Here, the cause value may indicate that the S-NSSAI is not supported in the TA, and/or that the S-NSSAI is partially unavailable in the current RA, and/or that the S-NSSAI is unavailable in the current TA, and/or that the S-NSSAI is partially unavailable in the current RA, and/or that the S-NSSAI is available in another TA, and/or that the S-NSSAI is available in another TA of the current RA. In addition, the AMF may transmit the DL NAS message to the UE by including the S-NSSAI and/or the cause value in the DL NAS message without transferring the PDU session establishment request message to the SMF.

### 4. Modifications

A program running on an apparatus according to an aspect of the present invention may serve as a program that controls a Central Processing Unit (CPU) and the like to cause a computer to function in such a manner as to realize the functions of the aforementioned embodiments according to the present invention. Programs or information handled by the programs are temporarily stored in a volatile memory such as a Random Access Memory (RAM), a non-volatile memory such as a flash memory, a Hard Disk Drive (HDD), or another storage apparatus system.

Note that a program for realizing such functions of the embodiment according to an aspect of the present invention may be recorded on a computer-readable recording medium. The functions may be realized by causing a computer system to read the program recorded on the recording medium and perform the program. It is assumed that the “computer system” refers to a computer system built into the apparatuses, and the computer system includes an operating system and hardware components such as a peripheral device. The “computer-readable recording medium” may be a semiconductor recording medium, an optical recording medium, a magnetic recording medium, a medium dynamically retaining the program for a short time, or any other computer-readable recording medium.

Each functional block or various features of the apparatuses used in the aforementioned embodiments may be implemented or performed on an electric circuit, for example, an integrated circuit or multiple integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or may be a processor of a known type, a controller, a micro-controller, or a state machine instead. The aforementioned electric circuit may include a digital circuit or may include an analog circuit. In addition, in a case that a circuit integration technology that replaces the present integrated circuits appears with advances in semiconductor technologies, one or multiple aspects of the present invention can also use a new integrated circuit based on the technology.

Note that the invention of the present application is not limited to the above-described embodiments. In the embodiment, apparatuses have been described as an example, but an aspect of the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

Although the embodiments of the present invention have been described in detail above referring to the drawings, the specific configuration is not limited to the embodiments and includes, for example, design changes within the scope that do not depart from the gist of the present invention. For an aspect of the present invention, various modifications are possible within the scope of the claims, and embodiments that are made by suitably combining technical means disclosed according to the different embodiments are also included in the technical scope of the present invention. A configuration in which elements described in the respective embodiments and having mutually similar effects are substituted for one another is also included.

1. A user equipment (UE) comprising:
transmission and reception circuitry;
a controller; and
storage circuitry,
wherein:
in a case that the UE supports a partial network slice, the transmission and reception circuitry is configured to transmit a registration request message including capability information indicating support for the partial network slice; and
in a case that the transmission and reception circuitry receives a Single Network Slice Selection Assistance Information (S-NSSAI) included in a first Network Slice Selection Assistance Information (NSSAI) included in a registration accept message or a configuration update command message, the controller is configured to store the S-NSSAI included in the first NSSAI in the storage circuitry,
wherein:
the first NSSAI includes one or more S-NSSAIs that are not available in some tracking areas in a registration area,
each S-NSSAI is associated with one or more tracking areas in which the S-NSSAI is not available, and
the controller is configured to delete the S-NSSAI and a list of the tracking areas from the storage circuitry after the UE moves out of the registration area.

2. The UE according to claim 1, wherein
the S-NSSAI included in the first NSSAI is not included in partially allowed NSSAI, and
the partially allowed NSSAI is an NSSAI including one or more S-NSSAIs that are available for the UE in some tracking areas in the current registration area.

3. The UE according to claim 1, wherein
the controller is configured to delete the first NSSAI from the storage circuitry in a case of entering 5GMM-DEREGISTERED state or 5GMM-REGISTERED state.

4. The UE according to claim 1, wherein
in a case that the transmission and reception circuitry receives a partially allowed NSSAI in the registration accept message, the controller is configured to store the partially allowed NSSAI as an allowed NSSAI in the storage circuitry.

5. A communication control method performed by a User Equipment (UE), the communication control method comprising:
in a case that the UE supports a partial network slice, transmitting a registration request message including capability information indicating support for the partial network slice; and
in a case that the UE receives a Single Network Slice Selection Assistance Information (S-NSSAI) included in a first Network Slice Selection Assistance Information (NSSAI) included in a registration accept message or a configuration update command message, storing the S-NSSAI included in the first NSSAI in the UE,
wherein:
the first NSSAI includes one or more S-NSSAIs that are not available in some tracking areas in a registration area,
each S-NSSAI is associated with one or more tracking areas in which the S-NSSAI is not available, and
the UE deletes the S-NSSAI and a list of the tracking areas from the UE after the UE moves out of the registration area.
